(19) United States
(12) Patent Application Publication
(10) Pub. No.: US 2025/0146527 A1
(43) Pub. Date: May 8, 2025

(54) LINEAR MOTION GUIDE UNIT

(71) Applicant: NIPPON THOMPSON CO., LTD., Tokyo (JP)

(72) Inventor: Yuichi SHIBUYA, Mino-shi (JP)

(73) Assignee: NIPPON THOMPSON CO., LTD., Tokyo (JP)

(21) Appl. No.: 18/730,136

(22) PCT Filed: Nov. 28, 2022
(86) PCT No.: PCT/JP2022/043705

§ 371 Date: Jul. 18, 2024

(30) Foreign Application Priority Data
Feb. 15, 2022 (JP) 2022-021347

(51) Int. Cl. F16C 29/00; F16C 29/06

(52) U.S. Cl. CPC F16C 29/005; F16C 29/008; F16C 29/063

(57) ABSTRACT

A linear motion guide unit includes a track rail having a first rail raceway surface and a second rail raceway surface each extending in a longitudinal direction, a first slider relatively movably attached to the track rail and having a first slider raceway surface facing the first rail raceway surface and a planar first mounting surface, and a second slider relatively movably attached to the track rail and having a second slider raceway surface facing the second rail raceway surface and a planar second mounting surface. The first slider is provided spaced apart from the second slider as viewed in the longitudinal direction. The second mounting surface is inclined with respect to the first mounting surface as viewed in the longitudinal direction.

### TECHNICAL FIELD

The present disclosure relates to a linear motion guide unit. The present application claims priority based on Japanese Patent Application No. 2022-021347 filed on Feb. 15, 2022, the entire contents of which are incorporated herein by reference.

### BACKGROUND ART

A linear motion guide unit including a plurality of sliders is known (see, for example, Patent Literature 1). According to the linear motion guide unit disclosed in Patent Literature 1, raceway grooves are formed on respective surfaces of a single track rail, and a plurality of sliders are straddled on these surfaces so as to be slidable relative to the rail.

### CITATION LIST

### Patent Literature

Patent Literature 1: Japanese Patent Application Laid-Open No. H8-261234

### SUMMARY OF INVENTION

### Technical Problem

In the linear motion guide unit disclosed in Patent Literature 1, the raceway grooves are formed on the respective surfaces of the track rail, so the sliders interfere with each other in the sliding directions of the sliders, i.e., in the directions in which the sliders perform linear motion. In such a configuration, the linear motion of each slider is restricted, which is not desirable from the standpoint of improvement in user convenience. Furthermore, from the standpoint of improving user convenience, it is desirable that a plurality of sliders attached at different angles can freely perform linear motion, without combining a plurality of linear motion guide units.

In view of the foregoing, one of the objects is to provide a linear motion guide unit that is capable of improving user convenience and allowing a plurality of sliders to freely perform linear motion.

### Solution to Problem

A linear motion guide unit according to the present disclosure includes: a track rail having a first rail raceway surface and a second rail raceway surface each extending in a longitudinal direction; a first slider relatively movably attached to the track rail, the first slider having a first slider raceway surface facing the first rail raceway surface and a planar first mounting surface provided with a first mounting hole for another member to be mounted; a second slider relatively movably attached to the track rail, the second slider having a second slider raceway surface facing the second rail raceway surface and a planar second mounting surface provided with a first mounting hole for another member to be mounted; a plurality of first rolling elements rolling on a first load-carrying race composed of the first rail raceway surface and the first slider raceway surface; and a plurality of second rolling elements rolling on a second load-carrying race composed of the second rail raceway surface and the second slider raceway surface. The first slider is provided spaced apart from the second slider as viewed in the longitudinal direction. The second mounting surface is inclined with respect to the first mounting surface as viewed in the longitudinal direction.

### Advantageous Effects of Invention

The linear motion guide unit described above can improve user convenience and allow a plurality of sliders to freely perform linear motion.

### BRIEF DESCRIPTION OF DRAWINGS

FIG. 1 is a schematic perspective view of a linear motion guide unit in Embodiment 1 of the present disclosure.

FIG. 2 is a schematic plan view of the linear motion guide unit shown in FIG. 1.

FIG. 3 is a schematic right side view of the linear motion guide unit shown in FIG. 1.

FIG. 4 is a schematic rear view of the linear motion guide unit shown in FIG. 1.

FIG. 5 is a view of the linear motion guide unit shown in FIG. 2, with the illustration of some members omitted.

FIG. 6 is a schematic cross-sectional view of the linear motion guide unit shown in FIG. 1, with the illustration of some members omitted.

FIG. 7 is a schematic cross-sectional view when cut in the cross section indicated by VII-VII in FIG. 2.

FIG. 8 is a schematic cross-sectional view when cut in the cross section indicated by VIII-VIII in FIG. 2.

FIG. 9 is an enlarged schematic perspective view of a first slider.

FIG. 10 is an enlarged schematic perspective view of a second slider.

FIG. 11 is a schematic perspective view of a linear motion guide unit in Embodiment 2 of the present disclosure.

FIG. 12 is a schematic plan view of the linear motion guide unit shown in FIG. 11.

FIG. 13 is a schematic perspective view of a linear motion guide unit in Embodiment 3 of the present disclosure.

FIG. 14 is a schematic plan view of the linear motion guide unit shown in FIG. 13.

FIG. 15 is a schematic perspective view of a linear motion guide unit in Embodiment 4 of the present disclosure.

FIG. 16 is a schematic plan view of the linear motion guide unit shown in FIG. 15.

FIG. 17 is a schematic perspective view of a linear motion guide unit in Embodiment 5 of the present disclosure.

FIG. 18 is a schematic plan view of the linear motion guide unit shown in FIG. 17.

### DESCRIPTION OF EMBODIMENTS

### Outline of Embodiments

A linear motion guide unit of the present disclosure includes: a track rail having a first rail raceway surface and a second rail raceway surface each extending in a longitudinal direction; a first slider relatively movably attached to the track rail, the first slider having a first slider raceway surface facing the first rail raceway surface and a planar first mounting surface provided with a first mounting hole for another member to be mounted; a second slider relatively movably attached to the track rail, the second slider having a second slider raceway surface facing the second rail raceway surface and a planar second mounting surface provided with a first mounting hole for another member to be mounted; a plurality of first rolling elements rolling on a first load-carrying race composed of the first rail raceway surface and the first slider raceway surface; and a plurality of second rolling elements rolling on a second load-carrying race composed of the second rail raceway surface and the second slider raceway surface. The first slider is provided spaced apart from the second slider as viewed in the longitudinal direction. The second mounting surface is inclined with respect to the first mounting surface as viewed in the longitudinal direction.

According to the linear motion guide unit of the present disclosure, the first slider and the second slider are provided spaced apart from each other as viewed in the longitudinal direction, so the first slider and the second slider do not interfere with each other as they perform linear motion. Then, the first slider and the second slider can each freely perform linear motion regardless of the position of the other slider. Furthermore, the second mounting surface is inclined with respect to the first mounting surface as viewed in the longitudinal direction. This makes it possible to utilize the sliders that perform linear motion at different angles, thereby improving user convenience. Therefore, such a linear motion guide unit can improve user convenience and allow a plurality of sliders to freely perform linear motion.

In the above linear motion guide unit, an angle of inclination of the second mounting surface with respect to the first mounting surface may be 90 degrees. The linear motion guide unit having such a configuration is suitably utilized when the user desires that the first slider and the second slider be positioned rotated by 90 degrees.

In the above linear motion guide unit, the track rail may further have a third rail raceway surface extending in the longitudinal direction. The linear motion guide unit may further include a third slider relatively movably attached to the track rail, the third slider having a third slider raceway surface facing the third rail raceway surface and a planar third mounting surface provided with a third mounting hole for another member to be mounted, and a plurality of third rolling elements rolling on a third load-carrying race composed of the third rail raceway surface and the third slider raceway surface. The third slider may be provided spaced apart from each of the first slider and the second slider as viewed in the longitudinal direction. The third mounting surface may be inclined with respect to at least one of the first mounting surface and the second mounting surface as viewed in the longitudinal direction. This configuration allows the third slider, in addition to the first and second sliders, to freely perform linear motion. Therefore, a larger number of sliders can freely perform linear motion, further improving user convenience.

In the above linear motion guide unit, the third mounting surface may be parallel to the first mounting surface as viewed in the longitudinal direction. With this, a linear motion guide unit having sliders arranged in the up-down direction can be obtained in a relatively compact configuration.

In the above linear motion guide unit, the track rail may further have a fourth rail raceway surface extending in the longitudinal direction. The linear motion guide unit may further include a fourth slider relatively movably attached to the track rail, the fourth slider having a fourth slider raceway surface facing the fourth rail raceway surface and a planar fourth mounting surface provided with a fourth mounting hole for another member to be mounted, and a plurality of fourth rolling elements rolling on a fourth load-carrying race composed of the fourth rail raceway surface and the fourth slider raceway surface. The fourth slider may be provided spaced apart from each of the first slider, the second slider, and the third slider as viewed in the longitudinal direction. The fourth mounting surface may be inclined with respect to at least one of the first mounting surface, the second mounting surface, and the third mounting surface as viewed in the longitudinal direction. This configuration allows the fourth slider, in addition to the first, second, and third sliders, to freely perform linear motion. Therefore, a larger number of sliders can freely perform linear motion, further improving user convenience.

In the above linear motion guide unit, the fourth mounting surface may be parallel to the second mounting surface as viewed in the longitudinal direction. With this, a linear motion guide unit having sliders arranged in the left-right direction can be obtained in a relatively compact configuration.

In the above linear motion guide unit, the track rail may include a first flat plate portion extending in the longitudinal direction and having a rectangular shape as viewed in a thickness direction, a second flat plate portion extending in the longitudinal direction and having a rectangular shape as viewed in a thickness direction, the second flat plate portion being arranged in a direction orthogonal to the first flat plate portion, and a third flat plate portion extending in the longitudinal direction and having a rectangular shape as viewed in a thickness direction, the third flat plate portion being arranged in a direction orthogonal to the first flat plate portion and parallel to the second flat plate portion. The first flat plate portion may include a first surface located on one side in the thickness direction and a second surface located on another side in the thickness direction. The second flat plate portion may be connected, at a central region of a surface on one side in the thickness direction, to one end of the first flat plate portion. The third flat plate portion may be connected, at a central region of a surface on another side in the thickness direction, to another end of the first flat plate portion. The first rail raceway surface may be provided in a pair, on the first surface side, one on the surface located on the one side in the thickness direction of the second flat plate portion and one on the surface located on the other side in the thickness direction of the third flat plate portion. The third rail raceway surface may be provided in a pair, on the second surface side, one on the surface located on the one side in the thickness direction of the second flat plate portion and one on the surface located on the other side in the thickness direction of the third flat plate portion. The second rail raceway surface may be provided in a pair, one on each of side surfaces of the second flat plate portion. The fourth rail raceway surface may be provided in a pair, one on each of side surfaces of the third flat plate portion. The linear motion guide unit having such a configuration can be made relatively thin in thickness and compact in configuration because the track rail has the configuration described above.

In the above linear motion guide unit, the track rail may include a first flat plate portion extending in the longitudinal direction and having a rectangular shape as viewed in a thickness direction, a second flat plate portion extending in the longitudinal direction and having a rectangular shape as viewed in a thickness direction, the second flat plate portion being arranged in a direction orthogonal to the first flat plate portion, and a third flat plate portion extending in the longitudinal direction and having a rectangular shape as viewed in a thickness direction, the third flat plate portion being arranged in a direction orthogonal to the first flat plate portion and parallel to the second flat plate portion. The first flat plate portion may include a first surface located on one side in the thickness direction and a second surface located on another side in the thickness direction. The first flat plate portion may include a first thick-walled portion protruding in the thickness direction from the first surface and a second thick-walled portion protruding in the thickness direction from the second surface. The second flat plate portion may be connected, at a central region of a surface on one side in the thickness direction, to one end of the first flat plate portion. The third flat plate portion may be connected, at a central region of a surface on another side in the thickness direction, to another end of the first flat plate portion. The first rail raceway surface may be provided in a pair, one on each of side surfaces of the first thick-walled portion. The third rail raceway surface may be provided in a pair, one on each of side surfaces of the second thick-walled portion. The second rail raceway surface may be provided in a pair, one on each of side surfaces of the second flat plate portion. The fourth rail raceway surface may be provided in a pair, one on each of side surfaces of the third flat plate portion. Such a linear motion guide unit can also improve user convenience and allow a plurality of sliders to freely perform linear motion. In this case, the thickness can be made relatively thin, so the linear motion guide unit can be made compact in its configuration.

In the above linear motion guide unit, the track rail may have a hollow quadrangular prism shape and include a first sidewall portion extending in the longitudinal direction and having a rectangular shape as viewed in a thickness direction, a second sidewall portion extending in the longitudinal direction and having a rectangular shape as viewed in a thickness direction, the second sidewall portion being arranged in a direction orthogonal to the first sidewall portion, a third sidewall portion extending in the longitudinal direction and having a rectangular shape as viewed in a thickness direction, the third sidewall portion being arranged in a direction orthogonal to the second sidewall portion and parallel to the first sidewall portion, and a fourth sidewall portion extending in the longitudinal direction and having a rectangular shape as viewed in a thickness direction, the fourth sidewall portion being arranged in a direction orthogonal to the first sidewall portion and parallel to the second sidewall portion. The first sidewall portion, the second sidewall portion, the third sidewall portion, and the fourth sidewall portion may include a first protruding portion, a second protruding portion, a third protruding portion, and a fourth protruding portion, respectively, which protrude outward. The first rail raceway surface may be provided in a pair, one on each of side surfaces of the first protruding portion. The second rail raceway surface may be provided in a pair, one on each of side surfaces of the second protruding portion. The third rail raceway surface may be provided in a pair, one on each of side surfaces of the third protruding portion. The fourth rail raceway surface may be provided in a pair, one on each of side surfaces of the fourth protruding portion. The linear motion guide unit having such a configuration can also improve user convenience and allow a plurality of sliders to freely perform linear motion. In this case, weight can be reduced while utilizing a plurality of sliders of the same type.

In the above linear motion guide unit, the track rail may have a shape in which a first plate-shaped portion and a second plate-shaped portion each extending in the longitudinal direction are crossed and connected to each other at centers thereof. The first plate-shaped portion may have one end provided with a first support portion of a flat plate shape extending in the longitudinal direction. The second plate-shaped portion may have one end provided with a second support portion of a flat plate shape extending in the longitudinal direction. The first plate-shaped portion may have another end provided with a third support portion of a flat plate shape extending in the longitudinal direction. The second plate-shaped portion may have another end provided with a fourth support portion of a flat plate shape extending in the longitudinal direction. The first rail raceway surface may be provided in a pair, one on each of side surfaces of the first support portion. The second rail raceway surface may be provided in a pair, one on each of side surfaces of the second support portion. The third rail raceway surface may be provided in a pair, one on each of side surfaces of the third support portion. The fourth rail raceway surface may be provided in a pair, one on each of side surfaces of the fourth support portion. In this manner, the linear motion guide unit having such a configuration can also improve user convenience and allow a plurality of sliders to freely perform linear motion. In this case, weight can be reduced while utilizing a plurality of sliders of the same type.

In the above linear motion guide unit, the track rail may have a hollow quadrangular prism shape and include a first sidewall portion extending in the longitudinal direction and having a rectangular shape as viewed in a thickness direction, a second sidewall portion extending in the longitudinal direction and having a rectangular shape as viewed in a thickness direction, the second sidewall portion being arranged in a direction orthogonal to the first sidewall portion, a third sidewall portion extending in the longitudinal direction and having a rectangular shape as viewed in a thickness direction, the third sidewall portion being arranged in a direction orthogonal to the second sidewall portion and parallel to the first sidewall portion, and a fourth sidewall portion extending in the longitudinal direction and having a rectangular shape as viewed in a thickness direction, the fourth sidewall portion being arranged in a direction orthogonal to the first sidewall portion and parallel to the second sidewall portion. The first sidewall portion, the second sidewall portion, the third sidewall portion, and the fourth sidewall portion may have a first groove-shaped portion, a second groove-shaped portion, a third groove-shaped portion, and a fourth groove-shaped portion, respectively, which extend in the longitudinal direction and are concaved inward. The first rail raceway surface may be provided in a pair, one in each of regions facing each other across the first groove-shaped portion. The second rail raceway surface may be provided in a pair, one in each of regions facing each other across the second groove-shaped portion. The third rail raceway surface may be provided in a pair, one in each of regions facing each other across the third groove-shaped portion. The fourth rail raceway surface may be provided in a pair, one in each of regions facing each other across the fourth groove-shaped portion. The linear motion guide unit having such a configuration can also improve user convenience and allow a plurality of sliders to freely perform linear motion. In this case, the rigidity of the track rail can be increased while allowing weight reduction.

In the above linear motion guide unit, at least one of the first rolling elements and the second rolling elements may be balls. With this, the configuration of the linear motion guide unit can be simplified.

### SPECIFIC EMBODIMENTS

Specific embodiments of the linear motion guide unit of the present disclosure will be described below with reference to the drawings. In the drawings referenced below, the same or corresponding portions are denoted by the same reference numerals and the description thereof will not be repeated.

### Embodiment 1

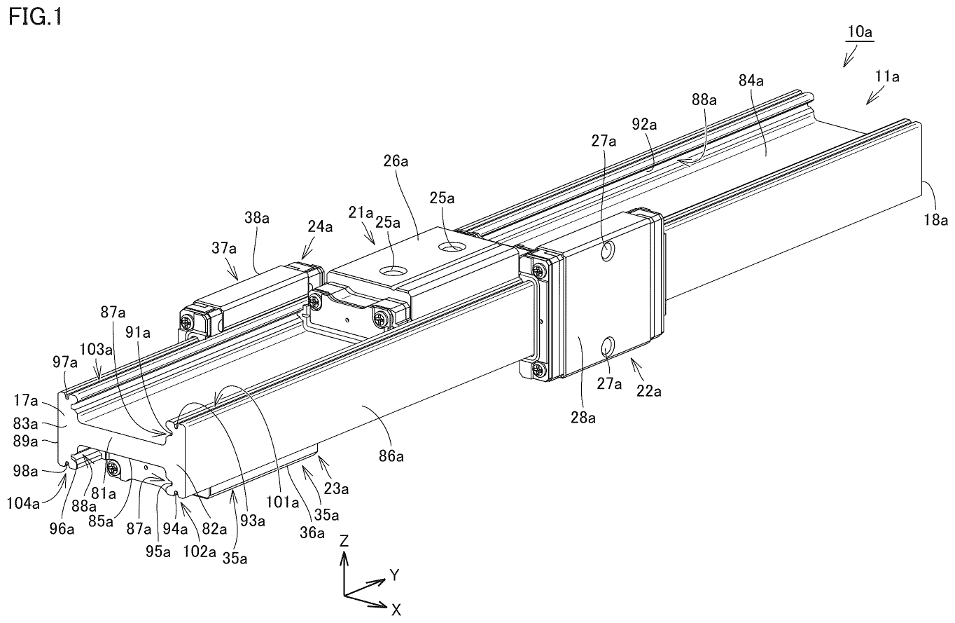

One embodiment of the present disclosure, Embodiment 1, will now be described. FIG. 1 is a schematic perspective view of a linear motion guide unit in Embodiment 1 of the present disclosure. In FIG. 1 and the following figures, the X direction indicates a lateral direction, which is the width direction of the linear motion guide unit, the Y direction indicates a longitudinal direction of the linear motion guide unit, and the Z direction indicates a thickness direction (depth direction) of the linear motion guide unit. The X, Y, and Z directions are orthogonal to each other. The linear motion guide unit of the present disclosure is mounted such that, for example, the longitudinal direction corresponds to the vertical direction. In FIG. 1 and the following figures, for convenience of explanation, one end surface side of a track rail, described later, is referred to as the upper side, the other end surface side is referred to as the lower side, the side on which a first slider is exposed is referred to as the back side, the side on which a third slider is exposed is referred to as the front side, the side on which a second slider is attached is referred to as the right side, and the side on which a fourth slider is attached is referred to as the left side. In other words, the X direction is the left-right direction, the Y direction is the front-back direction, and the Z direction is the up-down direction. The linear motion guide unit of the present disclosure is arranged to be mounted between a floor surface and a ceiling surface, for example, utilizing both ends of the track rail.

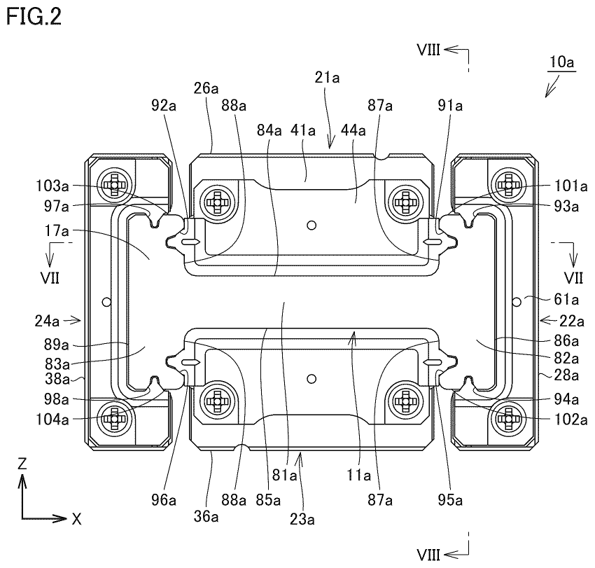

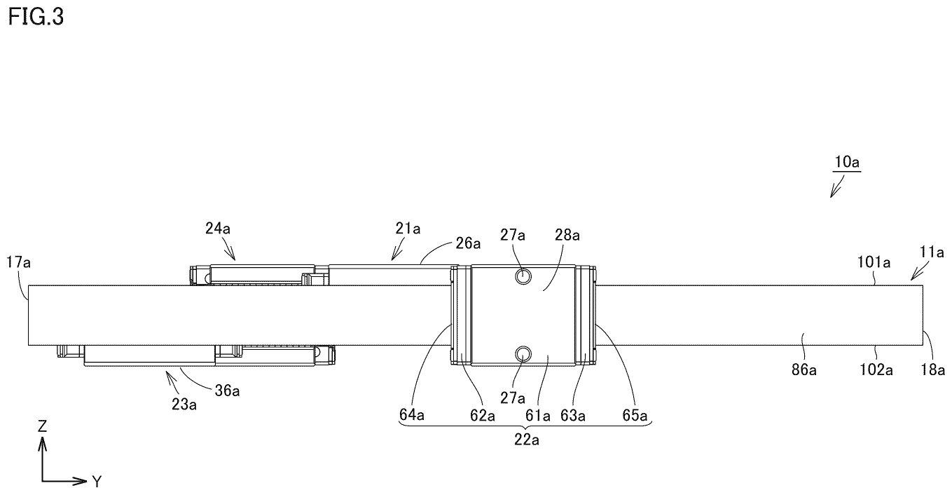

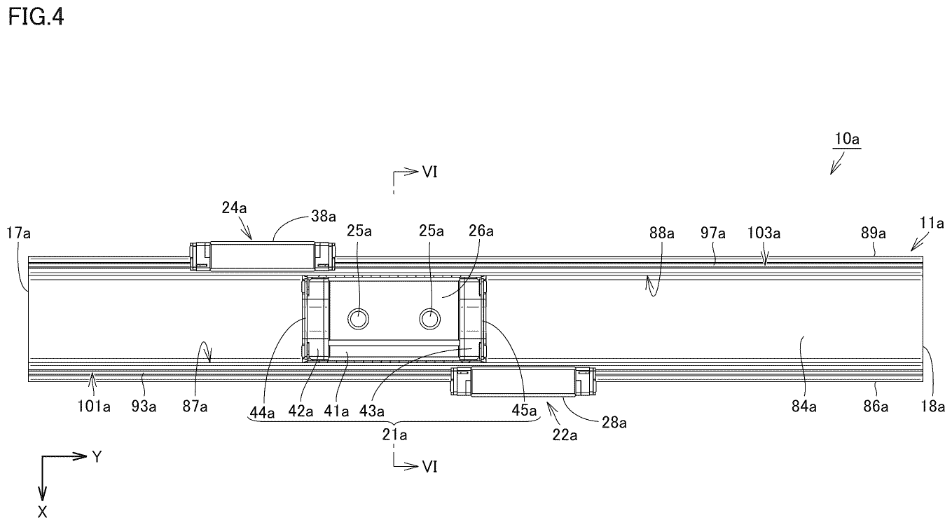

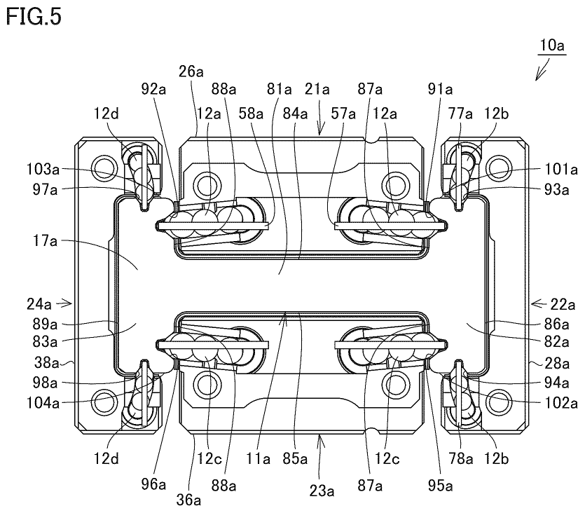

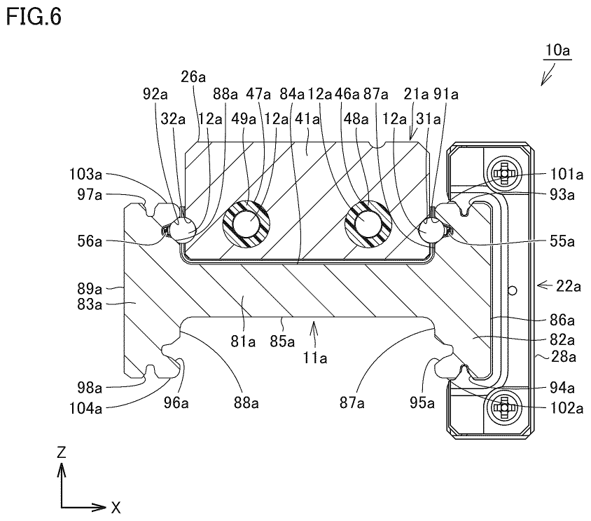

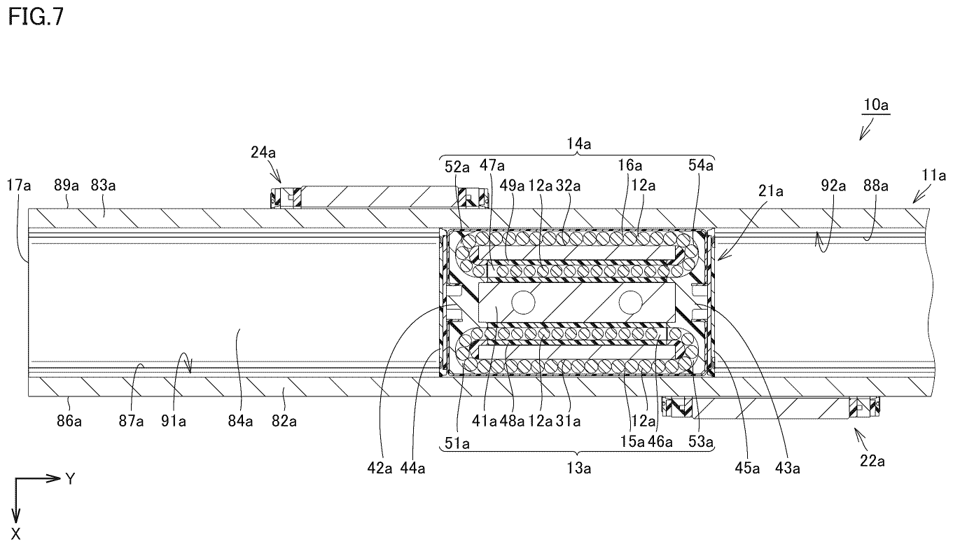

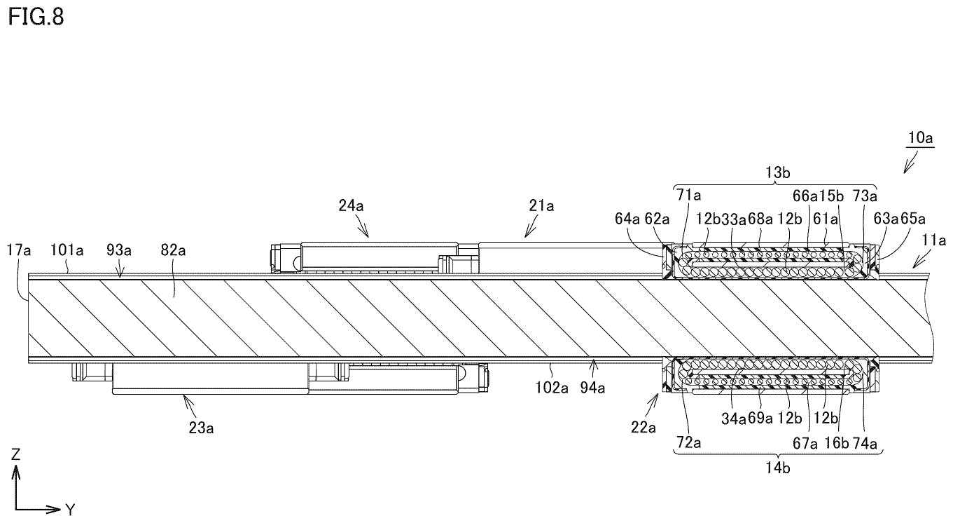

FIG. 2 is a schematic plan view of the linear motion guide unit shown in FIG. 1. FIG. 2 is a view of the linear motion guide unit shown in FIG. 1 in the direction indicated by the arrow Y. FIG. 3 is a schematic right side view of the linear motion guide unit shown in FIG. 1. FIG. 3 is a view of the linear motion guide unit shown in FIG. 1 in the direction opposite to the direction indicated by the arrow X. FIG. 4 is a schematic rear view of the linear motion guide unit shown in FIG. 1. FIG. 4 is a view of the linear motion guide unit shown in FIG. 1 in the direction opposite to the direction indicated by the arrow Z. FIG. 5 is a view of the linear motion guide unit shown in FIG. 2, with the illustration of some members omitted. FIG. 6 is a schematic cross-sectional view of the linear motion guide unit shown in FIG. 1, with the illustration of some members omitted. FIG. 6 is a schematic cross-sectional view when cut in the cross section indicated by VI-VI in FIG. 4. FIG. 7 is a schematic cross-sectional view when cut in the cross section indicated by VII-VII in FIG. 2. FIG. 8 is a schematic cross-sectional view when cut in the cross section indicated by VIII-VIII in FIG. 2.

Referring to FIGS. 1 to 8, the linear motion guide unit 10a according to Embodiment 1 of the present disclosure includes a track rail 11a as a shaft, a first slider 21a, a plurality of first balls 12a as a plurality of first rolling elements, a second slider 22a, a plurality of second balls 12b as a plurality of second rolling elements, a third slider 23a, a plurality of third balls 12c as a plurality of third rolling elements, a fourth slider 24a, and a plurality of fourth balls 12d as a plurality of fourth rolling elements. The track rail 11a is configured to extend straight in the longitudinal direction, the Y direction. The linear motion guide unit 10a according to Embodiment 1 is simplified in its configuration by including the first balls 12a as the first rolling elements, the second balls 12b as the second rolling elements, the third balls 12c as the third rolling elements, and the fourth balls 12d as the fourth rolling elements. The specific configuration of the track rail 11a will be described in detail later.

The first slider 21a, the second slider 22a, the third slider 23a, and the fourth slider 24a are each relatively movably attached to the track rail 11a. In the present embodiment, the first slider 21a is attached to the back side of the track rail 11a. The second slider 22a is attached to the right side of the track rail 11a. The third slider 23a is attached to the front side of the track rail 11a. The fourth slider 24a is attached to the left side of the track rail 11a. The first slider 21a, the second slider 22a, the third slider 23a, and the fourth slider 24a are each configured to be movable in the longitudinal direction (Y direction). The track rail 11a and the first slider 21a form first looped paths 13a and 14a for the first balls 12a to circulate therethrough. The track rail 11a and the second slider 22a form second looped paths 13b and 14b for the second balls 12b to circulate therethrough. The track rail 11a and the third slider 23a form third looped paths (not shown) for the third balls 12c to circulate therethrough. The track rail 11a and the fourth slider 24a form fourth looped paths (not shown) for the fourth balls 12d to circulate therethrough.

The first slider 21a has a pair of first slider raceway surfaces 31a, 32a and a planar first mounting surface 26a provided with a first mounting hole 25a for another member to be mounted (see in particular FIG. 7). Two such first mounting holes 25a are provided apart from each other in the Y direction. The second slider 22a has a pair of second slider raceway surfaces 33a, 34a and a planar second mounting surface 28a provided with a second mounting hole 27a for another member to be mounted (see in particular FIG. 8). Two such second mounting holes 27a are provided apart from each other in the Z direction. The third slider 23a has a pair of third slider raceway surfaces (not shown) and a planar third mounting surface 36a provided with a third mounting hole 35a for another member to be mounted. Two such third mounting holes 35a are provided apart from each other in the Y direction. The fourth slider 24a has a pair of fourth slider raceway surfaces (not shown) and a planar fourth mounting surface 38a provided with a fourth mounting hole 37a for another member to be mounted. Two such fourth mounting holes 37a are provided apart from each other in the Z direction. The first slider raceway surfaces 31a and 32a, the second slider raceway surfaces 33a and 34a, the third slider raceway surfaces, and the fourth slider raceway surfaces each have a groove shape extending in the longitudinal direction and are concaved in a semicircular arc shape. The pair of first slider raceway surfaces 31a and 32a are provided apart from each other in the X direction. The pair of second slider raceway surfaces 33a and 34a are provided apart from each other in the Z direction. The pair of third slider raceway surfaces are provided apart from each other in the X direction. The pair of fourth slider raceway surfaces are provided apart from each other in the Z direction. On the first mounting surface 26a of the first slider 21a, another member to be slid in the Y direction is mounted utilizing the pair of first mounting holes 25a. On the second mounting surface 28a of the second slider 22a, another member to be slid in the Y direction is mounted utilizing the pair of second mounting holes 27a. On the third mounting surface 36a of the third slider 23a, another member to be slid in the Y direction is mounted utilizing the pair of third mounting holes 35a. On the fourth mounting surface 38a of the fourth slider 24a, another member to be slid in the Y direction is mounted utilizing the pair of fourth mounting holes 37a.

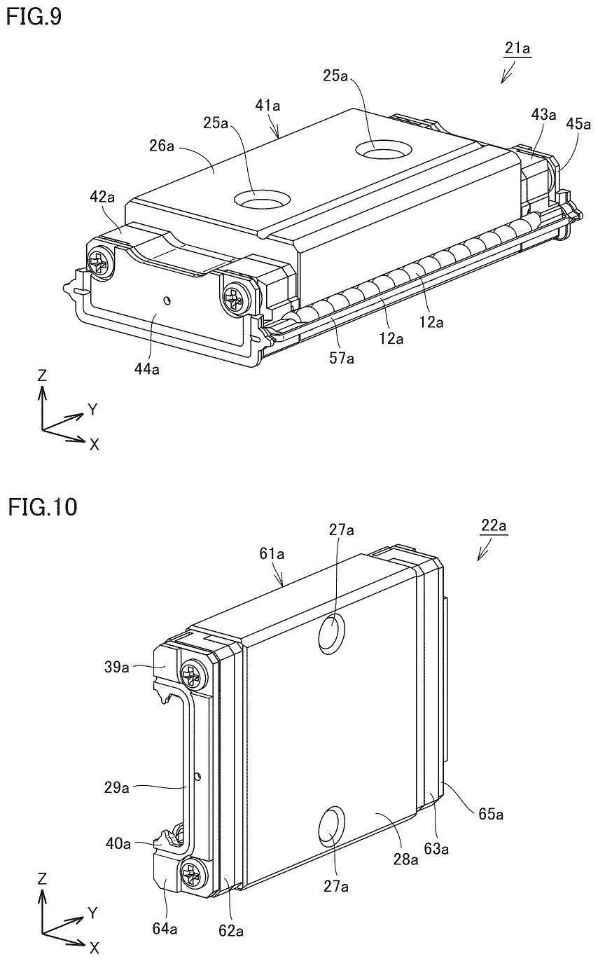

The configuration of the first slider 21a will now be described. FIG. 9 is an enlarged schematic perspective view of the first slider 21a. Referring also to FIG. 9, the first slider 21a has a flat plate shape with its thickness direction corresponding to the Z direction. The first slider 21a includes a first carriage 41a, a first upper-side end cap 42a, a first lower-side end cap 43a, a first upper-side end seal 44a, and a first lower-side end seal 45a. The first upper-side end cap 42a and the first upper-side end seal 44a are attached to an upper side of the first carriage 41a by bolts. The first lower-side end cap 43a and the first lower-side end seal 45a are attached to a lower side of the first carriage 41a by bolts.

The first carriage 41a has first carriage circulation passages 46a and 47a, which penetrate in the longitudinal direction and are sized to allow the first balls 12a to pass therethrough (see in particular FIG. 7). The first carriage circulation passages 46a and 47a are provided spaced apart in the X direction. The first carriage circulation passages 46a and 47a are also called return passages. In the first carriage circulation passages 46a and 47a, hollow cylindrical lubricating members 48a and 49a impregnated with lubricant are disposed. By the first balls 12a passing through the hollow cylindrical lubricating members 48a and 49a, lubricant can be supplied to the surfaces of the first balls 12a. The first carriage 41a also has the first slider raceway surfaces 31a and 32a described above.

The first upper-side end cap 42a has first upper-side end cap circulation passages 51a and 52a provided therein. The first lower-side end cap 43a has first lower-side end cap circulation passages 53a and 54a provided therein. The first upper-side end cap circulation passages 51a, 52a and the first lower-side end cap circulation passages 53a, 54a are also called turnaround passages. The first looped path 13a is formed by a first load-carrying race 15a, which is composed of a first rail raceway surface 91a, described later, and the first slider raceway surface 31a, the first carriage circulation passage 46a, the first upper-side end cap circulation passage 51a, and the first lower-side end cap circulation passage 53a. The first looped path 14a is formed by a first load-carrying race 16a, which is composed of a first rail raceway surface 92a, described later, and the first slider raceway surface 32a, the first carriage circulation passage 47a, the first upper-side end cap circulation passage 52a, and the first lower-side end cap circulation passage 54a.

The first slider 21a includes first retaining bands 57a and 58a (see in particular FIG. 5). The first balls 12a are retained in the first slider 21a by the first retaining bands 57a and 58a so as to circulate in the first looped paths 13a and 14a.

The configuration of the second slider 22a will now be described. FIG. 10 is an enlarged schematic perspective view of the second slider 22a. Referring also to FIG. 10, the second slider 22a has a shape including a flat plate-shaped base portion 29a and a pair of sleeve portions 39a and 40a extending from the base portion 29a. The base portion 29a has a flat plate shape with its thickness direction corresponding to the X direction. The second slider 22a includes a second carriage 61a, a second upper-side end cap 62a, a second lower-side end cap 63a, a second upper-side end seal 64a, and a second lower-side end seal 65a. The second upper-side end cap 62a and the second upper-side end seal 64a are attached to an upper side of the second carriage 61a by bolts. The second lower-side end cap 63a and the second lower-side end seal 65a are attached to a lower side of the second carriage 61a by bolts.

The second carriage 61a has second carriage circulation passages 66a and 67a, which penetrate in the longitudinal direction and are sized to allow the second balls 12b to pass therethrough (see in particular FIG. 8). The second carriage circulation passages 66a and 67a are provided spaced apart in the Z direction. The second carriage circulation passages 66a and 67a are also called return passages. In the second carriage circulation passages 66a and 67a, hollow cylindrical lubricating members 68a and 69a impregnated with lubricant are disposed. By the second balls 12b passing through the hollow cylindrical lubricating members 68a and 69a, lubricant can be supplied to the surfaces of the second balls 12b. The second carriage 61a also has the second slider raceway surfaces 33a and 34a described above.

The second upper-side end cap 62a has second upper-side end cap circulation passages 71a and 72a provided therein. The second lower-side end cap 63a has second lower-side end cap circulation passages 73a and 74a provided therein. The second upper-side end cap circulation passages 71a, 72a and the second lower-side end cap circulation passages 73a, 74a are also called turnaround passages. The second looped path 13b is formed by a second load-carrying race 15b, which is composed of a second rail raceway surface 93a, described later, and the second slider raceway surface 33a, the second carriage circulation passage 66a, the second upper-side end cap circulation passage 71a, and the second lower-side end cap circulation passages 73a. The second looped path 14b is formed by a second load-carrying race 16b, which is composed of a second rail raceway surface 94a, described later, and the second slider raceway surface 34a, the second carriage circulation passage 67a, the second upper-side end cap circulation passage 72a, and the second lower-side end cap circulation passage 74a.

The second slider 22a includes second retaining bands 77a and 78a (see in particular FIG. 5). The second balls 12b are retained in the second slider 22a by the second retaining bands 77a and 78a so as to circulate in the second looped paths 13b and 14b.

It should be noted that the third slider 23a has the same configuration as the first slider 21a, so the description thereof will not be repeated. The fourth slider 24a has the same configuration as the second slider 22a, so the description thereof will not be repeated.

The configuration of the track rail 11a will now be described. The track rail 11a has a shape extending in the longitudinal direction (Y direction). The track rail 11a includes a rail upper end surface 17a and a rail lower end surface 18a spaced apart in the Y direction.

The track rail 11a includes a first flat plate portion 81a, a second flat plate portion 82a, and a third flat plate portion 83a. The first flat plate portion 81a, the second flat plate portion 82a, and the third flat plate portion 83a each extend in the longitudinal direction (Y direction) and are rectangular as viewed in their thickness directions. The first flat plate portion 81a includes a first surface 84a located on one side in the thickness direction (Z direction) and a second surface 85a located on the other side in the thickness direction. The second flat plate portion 82a includes a surface 86a located on one side in the thickness direction (X direction) and a surface 87a located on the other side in the thickness direction. The third flat plate portion 83a includes a surface 88a located on one side in the thickness direction (X direction) and a surface 89a located on the other side in the thickness direction. In the present embodiment, the first flat plate portion 81a is parallel to the X-Y plane, and the second flat plate portion 82a and the third flat plate portion 83a are each parallel to the Y-Z plane. The second flat plate portion 82a is arranged in a direction orthogonal to the first flat plate portion 81a. The third flat plate portion 83a is arranged in a direction orthogonal to the first flat plate portion 81a. The second flat plate portion 82a and the third flat plate portion 83a are arranged in parallel, spaced apart in the X direction. The surface 87a on the one side in the thickness direction of the second flat plate portion 82a and the surface 88a on the other side in the thickness direction of the third flat plate portion 83a face each other in the X direction.

The second flat plate portion 82a is continuous to one end in the X direction of the first flat plate portion 81a. The second flat plate portion 82a is connected to the first flat plate portion 81a at a central region of the surface 87a on the one side in the thickness direction (X direction). The third flat plate portion 83a is continuous to the other end in the X direction of the first flat plate portion 81a. The third flat plate portion 83a is connected to the first flat plate portion 81a at a central region of the surface 88a on the other side in the thickness direction (X direction).

A first rail raceway surface 91a is provided, on the first surface 84a side, on the surface 87a located on the one side in the thickness direction of the second flat plate portion 82a. A first rail raceway surface 92a is provided, on the first surface 84a side, on the surface 88a located on the other side in the thickness direction of the third flat plate portion 83a. A second rail raceway surface 93a is provided on one side surface 101a of the second flat plate portion 82a. A second rail raceway surface 94a is provided on another side surface 102a of the second flat plate portion 82a. A third rail raceway surface 95a is provided, on the second surface 85a side, on the surface 87a located on the one side in the thickness direction of the second flat plate portion 82a. A third rail raceway surface 96a is provided, on the second surface 85a side, on the surface 88a located on the other side in the thickness direction of the third flat plate portion 83a. A fourth rail raceway surface 97a is provided on one side surface 103a of the third flat plate portion 83a. A fourth rail raceway surface 98a is provided on another side surface 104a of the third flat plate portion 83a. The first rail raceway surfaces 91a and 92a, the second rail raceway surfaces 93a and 94a, the third rail raceway surfaces 95a and 96a, and the fourth rail raceway surfaces 97a and 98a each have a groove shape extending in the longitudinal direction and are concaved in a semicircular arc shape.

Here, the first slider 21a, the second slider 22a, the third slider 23a, and the fourth slider 24a are provided spaced apart from each other as viewed in the longitudinal direction. Specifically, there is a clearance between the first slider 21a and the second slider 22a. There is a clearance between the first slider 21a and the fourth slider 24a. There is a clearance between the third slider 23a and the second slider 22a. There is a clearance between the third slider 23a and the fourth slider 24a.

As viewed in the longitudinal direction, the first slider 21a and the third slider 23a are arranged in parallel, spaced apart in the Z direction. The first flat plate portion 81a is interposed between the first slider 21a and the third slider 23a. The second slider 22a and the fourth slider 24a are arranged in parallel, spaced apart in the X direction. The first flat plate portion 81a is interposed between the second slider 22a and the fourth slider 24a.

As viewed in the longitudinal direction, the second mounting surface 28a is inclined with respect to the first mounting surface 26a. In the present embodiment, the angle of inclination of the second mounting surface 28a with respect to the first mounting surface 26a is 90 degrees. Furthermore, as viewed in the longitudinal direction, the fourth mounting surface 38a is inclined with respect to the first mounting surface 26a. In the present embodiment, the angle of inclination of the fourth mounting surface 38a with respect to the first mounting surface 26a is 90 degrees. It should be noted that the first mounting surface 26a and the third mounting surface 36a are arranged in parallel as viewed in the longitudinal direction. In the present embodiment, the first mounting surface 26a and the third mounting surface 36a are each parallel to the X-Y plane. The second mounting surface 28a and the fourth mounting surface 38a are arranged in parallel as viewed in the longitudinal direction. In the present embodiment, the second mounting surface 28a and the fourth mounting surface 38a are each parallel to the Y-Z plane. In other words, the first mounting surface 26a, the second mounting surface 28a, the third mounting surface 36a, and the fourth mounting surface 38a are configured to be positioned rotated by 90 degrees each.

According to the linear motion guide unit 10a configured as above, the first slider 21a and the second slider 22a are provided spaced apart from each other as viewed in the longitudinal direction, so the first slider 21a and the second slider 22a do not interfere with each other as they perform linear motion. Then, the first slider 21a and the second slider 22a can each freely perform linear motion regardless of the position of the other slider. As viewed in the longitudinal direction, the second mounting surface 28a is inclined with respect to the first mounting surface 26a. This makes it possible to utilize the sliders that perform linear motion at different angles, thereby improving user convenience. Therefore, such a linear motion guide unit 10a can improve user convenience and allow a plurality of sliders to freely perform linear motion.

In the present embodiment, the first slider 21a, the second slider 22a, the third slider 23a, and the fourth slider 24a are provided spaced apart from each other as viewed in the longitudinal direction, so the first slider 21a, the second slider 22a, the third slider 23a, and the fourth slider 24a do not interfere with each other as they perform linear motion. Then, the first slider 21a, the second slider 22a, the third slider 23a, and the fourth slider 24a can each freely perform linear motion regardless of the positions of the other sliders. In addition, as viewed in the longitudinal direction, the second mounting surface 28a and the fourth mounting surface 38a are each inclined with respect to the first mounting surface 26a. As viewed in the longitudinal direction, the second mounting surface 28a and the fourth mounting surface 38a are each inclined with respect to the third mounting surface 36a. This makes it possible to utilize the sliders that perform linear motion at different angles, thereby improving user convenience. Therefore, such a linear motion guide unit 10a can improve user convenience and allow a plurality of sliders to freely perform linear motion.

In the present embodiment, since the track rail 11a has the configuration described above, the thickness in the Z direction (thickness in the depth direction) can be made relatively thin, and the linear motion guide unit 10a can be made compact in its configuration.

In the present embodiment, the fourth mounting surface 38a is parallel to the second mounting surface 28a as viewed in the longitudinal direction. Thus, the linear motion guide unit 10a having sliders arranged in the left-right direction can be obtained in a relatively compact configuration.

In the present embodiment, the third mounting surface 36a is parallel to the first mounting surface 26a as viewed in the longitudinal direction. Thus, the linear motion guide unit 10a having sliders arranged in the front-back direction can be obtained in a relatively compact configuration.

In the present embodiment, the angle of inclination of the second mounting surface 28a with respect to the first mounting surface 26a is 90 degrees. The linear motion guide unit 10a having such a configuration is suitably utilized when the user desires that the first slider 21a and the second slider 22a be positioned rotated by 90 degrees.

### Embodiment 2

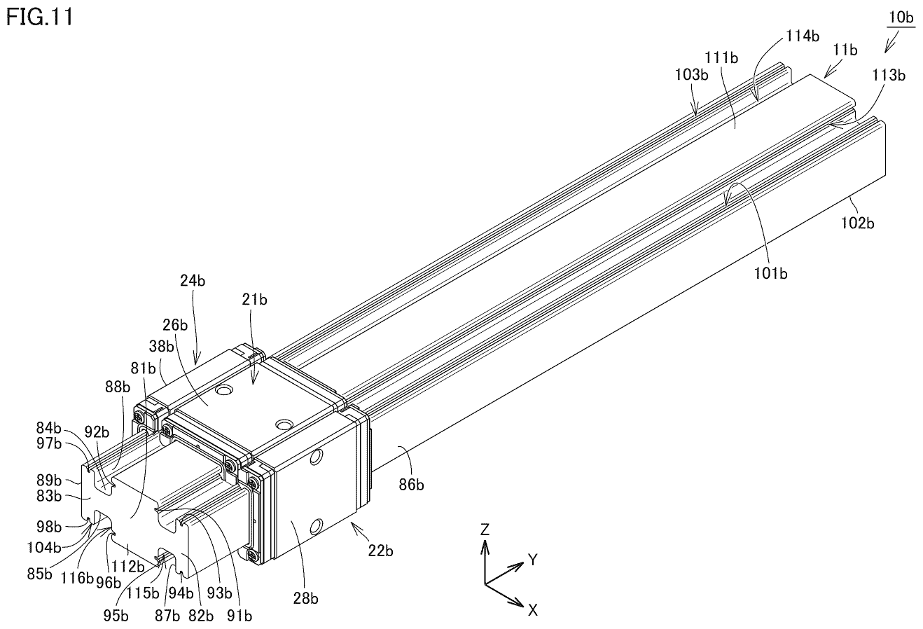

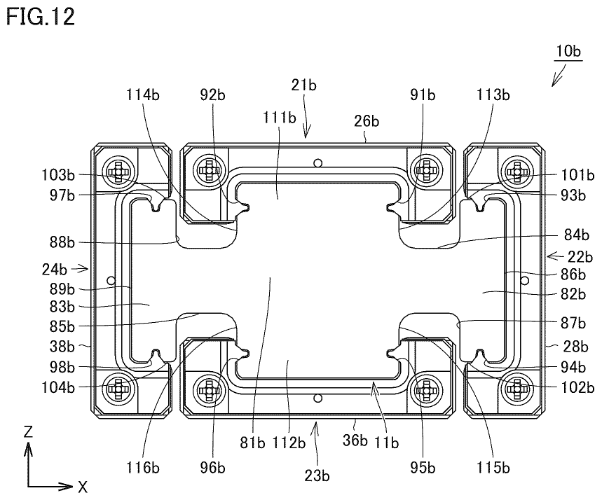

Another embodiment, Embodiment 2, will now be described. FIG. 11 is a schematic perspective view of a linear motion guide unit in Embodiment 2 of the present disclosure. FIG. 12 is a schematic plan view of the linear motion guide unit shown in FIG. 11. FIG. 12 is a view of the linear motion guide unit shown in FIG. 11 in the direction indicated by the arrow Y. The linear motion guide unit in Embodiment 2 basically has a similar configuration and provides similar effects as in the case of Embodiment 1. However, the linear motion guide unit of Embodiment 2 differs from the case of Embodiment 1 in the configurations of the track rail and the sliders.

Referring to FIGS. 11 and 12, the linear motion guide unit 10b of Embodiment 2 includes a track rail 11b, a first slider 21b, a plurality of first balls (not shown) as a plurality of first rolling elements, a second slider 22b, a plurality of second balls (not shown) as a plurality of second rolling elements, a third slider 23b, a plurality of third balls (not shown) as a plurality of third rolling elements, a fourth slider 24b, and a plurality of fourth balls (not shown) as a plurality of fourth rolling elements. The track rail 11b is configured to extend straight in the longitudinal direction, the Y direction.

The first slider 21b, the second slider 22b, the third slider 23b, and the fourth slider 24b are each relatively movably attached to the track rail 11b. In the present embodiment, the first slider 21b is attached to the back side of the track rail 11b. The second slider 22b is attached to the right side of the track rail 11b. The third slider 23b is attached to the front side of the track rail 11b. The fourth slider 24b is attached to the left side of the track rail 11b. The first slider 21b, the second slider 22b, the third slider 23b, and the fourth slider 24b are each configured to be movable in the longitudinal direction (Y direction).

The first slider 21b, the second slider 22b, the third slider 23b, and the fourth slider 24b each have the same configuration as the second slider 22a of Embodiment 1 described above, so the description thereof will not be repeated. In other words, in the present embodiment, sliders that all have the same configuration are used.

The track rail 11b includes a first flat plate portion 81b, a second flat plate portion 82b, and a third flat plate portion 83b. The first flat plate portion 81b, the second flat plate portion 82b, and the third flat plate portion 83b each extend in the longitudinal direction (Y direction) and are rectangular as viewed in their thickness directions. The first flat plate portion 81b includes a first surface 84b located on one side in the thickness direction (Z direction) and a second surface 85b located on the other side in the thickness direction. The second flat plate portion 82b includes a surface 86b located on one side in the thickness direction (X direction) and a surface 87b located on the other side in the thickness direction. The third flat plate portion 83b includes a surface 88b located on one side in the thickness direction (X direction) and a surface 89b located on the other side in the thickness direction. In the present embodiment, the first flat plate portion 81b is parallel to the X-Y plane, and the second flat plate portion 82b and the third flat plate portion 83b are each parallel to the Y-Z plane. The second flat plate portion 82b is arranged in a direction orthogonal to the first flat plate portion 81b. The third flat plate portion 83b is arranged in a direction orthogonal to the first flat plate portion 81b. The second flat plate portion 82b and the third flat plate portion 83b are arranged in parallel, spaced apart in the X direction. The surface 87b on the one side in the thickness direction of the second flat plate portion 82b and the surface 88b on the other side in the thickness direction of the third flat plate portion 83b face each other in the X direction.

The first flat plate portion 81b has thick-walled portions 111b and 112b, which protrude in the thickness direction. The thick-walled portion 111b is provided on the first surface 84b. The thick-walled portion 112b is provided on the second surface 85b. The thick-walled portion 111b has side surfaces 113b and 114b on which first rail raceway surfaces 91b and 92b are provided. Specifically, the first rail raceway surface 91b is provided on the side surface 113b of the thick-walled portion 111b facing the surface 87b on the one side of the second flat plate portion 82b. The first rail raceway surface 92b is provided on the side surface 114b of the thick-walled portion 111b facing the surface 88b on the other side of the third flat plate portion 83b. The thick-walled portion 112b has side surfaces 115b and 116b on which third rail raceway surfaces 95b and 96b are provided. Specifically, the third rail raceway surface 95b is provided on the side surface 115b of the thick-walled portion 112b facing the surface 87b on the one side of the second flat plate portion 82b. The third rail raceway surface 96b is provided on the side surface 116b of the thick-walled portion 112b facing the surface 88b on the other side of the third flat plate portion 83b. It should be noted that second rail raceway surfaces 93b and 94b are provided on both side surfaces 101b and 102b of the second flat plate portion 82b, as in Embodiment 1. Also as in Embodiment 1, fourth rail raceway surfaces 97b and 98b are provided on both side surfaces 103b and 104b of the third flat plate portion 83b.

As viewed in the longitudinal direction, the first slider 21b, the second slider 22b, the third slider 23b, and the fourth slider 24b are provided spaced apart from each other. Specifically, there is a clearance between the first slider 21b and the second slider 22b. There is a clearance between the first slider 21b and the fourth slider 24b. There is a clearance between the third slider 23b and the second slider 22b. There is a clearance between the third slider 23b and the fourth slider 24b.

As viewed in the longitudinal direction, the first slider 21b and the third slider 23b are arranged in parallel, spaced apart in the Z direction. The first flat plate portion 81b is interposed between the first slider 21b and the third slider 23b. The second slider 22b and the fourth slider 24b are arranged in parallel, spaced apart in the X direction. The first flat plate portion 81b is interposed between the second slider 22b and the fourth slider 24b.

As viewed in the longitudinal direction, a planar second mounting surface 28b, which is included in the second slider 22b and is provided with a second mounting hole for another member to be mounted, is inclined with respect to a planar first mounting surface 26b, which is included in the first slider 21b and is provided with a first mounting hole for another member to be mounted. In the present embodiment, the angle of inclination of the second mounting surface 28b with respect to the first mounting surface 26b is 90 degrees. Further, as viewed in the longitudinal direction, a planar fourth mounting surface 38b, which is included in the fourth slider 24b and is provided with a fourth mounting hole for another member to be mounted, is inclined with respect to the first mounting surface 26b. In the present embodiment, the angle of inclination of the fourth mounting surface 38b with respect to the first mounting surface 26b is 90 degrees. It should be noted that as viewed in the longitudinal direction, the first mounting surface 26b and a planar third mounting surface 36b, which is included in the third slider 23b and is provided with a third mounting hole for another member to be mounted, are arranged in parallel. In the present embodiment, the first mounting surface 26b and the third mounting surface 36b are each parallel to the X-Y plane. As viewed in the longitudinal direction, the second mounting surface 28b and the fourth mounting surface 38b are arranged in parallel. In the present embodiment, the second mounting surface 28b and the fourth mounting surface 38b are each parallel to the Y-Z plane. In other words, the first mounting surface 26b, the second mounting surface 28b, the third mounting surface 36b, and the fourth mounting surface 38b are configured to be positioned rotated by 90 degrees each.

Such a linear motion guide unit 10b can also improve user convenience and allow a plurality of sliders to freely perform linear motion. In the present embodiment, the thickness in the Z direction can be made relatively thin, so the linear motion guide unit 10b can be made compact in its configuration.

### Embodiment 3

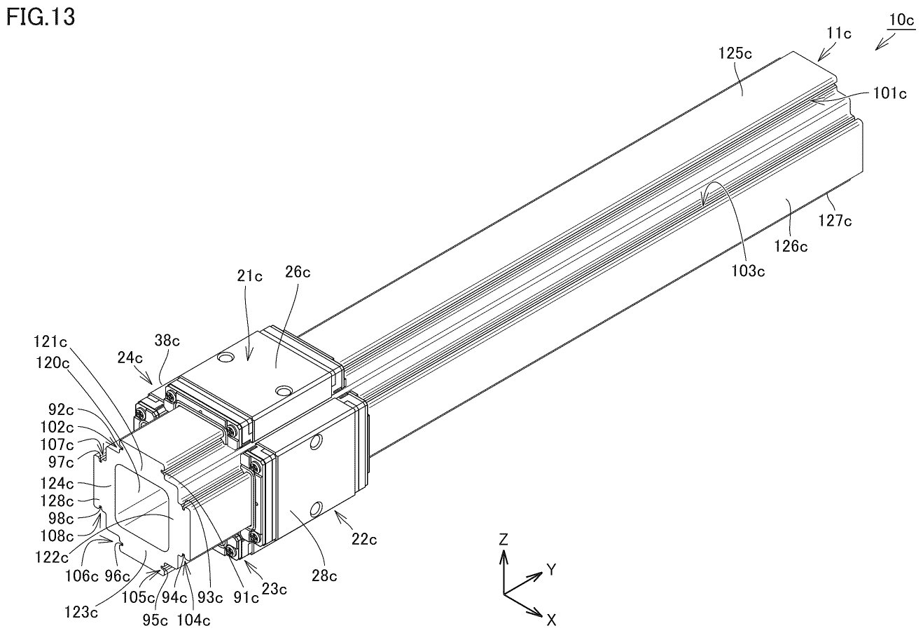

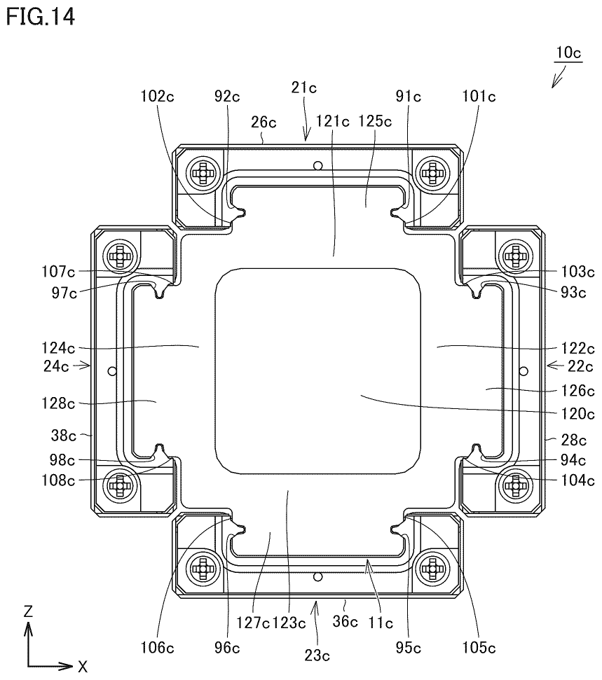

Yet another embodiment, Embodiment 3, will now be described. FIG. 13 is a schematic perspective view of a linear motion guide unit in Embodiment 3 of the present disclosure. FIG. 14 is a schematic plan view of the linear motion guide unit shown in FIG. 13. FIG. 14 is a view of the linear motion guide unit shown in FIG. 13 in the direction indicated by the arrow Y. The linear motion guide unit in Embodiment 3 basically has a similar configuration and provides similar effects as in the case of Embodiment 1. However, the linear motion guide unit of Embodiment 3 differs from the case of Embodiment 1 in the configurations of the track rail and the sliders.

Referring to FIGS. 13 and 14, the linear motion guide unit 10c of Embodiment 3 includes a track rail 11c, a first slider 21c, a plurality of first balls (not shown) as a plurality of first rolling elements, a second slider 22c, a plurality of second balls (not shown) as a plurality of second rolling elements, a third slider 23c, a plurality of third balls (not shown) as a plurality of third rolling elements, a fourth slider 24c, and a plurality of fourth balls (not shown) as a plurality of fourth rolling elements. The track rail 11c is configured to extend straight in the longitudinal direction, the Y direction.

The first slider 21c, the second slider 22c, the third slider 23c, and the fourth slider 24c are each relatively movably attached to the track rail 11c. In the present embodiment, the first slider 21c is attached to the back side of the track rail 11c. The second slider 22c is attached to the right side of the track rail 11c. The third slider 23c is attached to the front side of the track rail 11c. The fourth slider 24c is attached to the left side of the track rail 11c. The first slider 21c, the second slider 22c, the third slider 23c, and the fourth slider 24c are each configured to be movable in the longitudinal direction (Y direction).

The first slider 21c, the second slider 22c, the third slider 23c, and the fourth slider 24c each have the same configuration as the second slider 22a of Embodiment 1 described above, so the description thereof will not be repeated. In other words, in the present embodiment, sliders that all have the same configuration are used.

The track rail 11c has a hollow quadrangular prism shape. That is, the track rail 11c has a through hole 120c penetrating therethrough in the longitudinal direction. The track rail 11c includes a first sidewall portion 121c, a second sidewall portion 122c, a third sidewall portion 123c, and a fourth sidewall portion 124c. The first sidewall portion 121c extends in the longitudinal direction and has a rectangular shape as viewed in its thickness direction. The second sidewall portion 122c extends in the longitudinal direction and has a rectangular shape as viewed in its thickness direction, and is arranged in a direction orthogonal to the first sidewall portion 121c. The third sidewall portion 123c extends in the longitudinal direction and has a rectangular shape as viewed in its thickness direction, and is arranged in a direction orthogonal to the second sidewall portion 122c and parallel to the first sidewall portion 121c. The fourth sidewall portion 124c extends in the longitudinal direction and has a rectangular shape as viewed in its thickness direction, and is arranged in a direction orthogonal to the first sidewall portion 121c and parallel to the second sidewall portion 122c. The through hole 120c is formed by the first sidewall portion 121c, the second sidewall portion 122c, the third sidewall portion 123c, and the fourth sidewall portion 124c.

The first sidewall portion 121c, the second sidewall portion 122c, the third sidewall portion 123c, and the fourth sidewall portion 124c include a first protruding portion 125c, a second protruding portion 126c, a third protruding portion 127c, and a fourth protruding portion 128c, respectively, which protrude outward. First rail raceway surfaces 91c and 92c are provided as a pair, one on each of side surfaces 101c and 102c of the first protruding portion 125c. Second rail raceway surfaces 93c and 94c are provided as a pair, one on each of side surfaces 103c and 104c of the second protruding portion 126c. Third rail raceway surfaces 95c and 96c are provided as a pair, one on each of side surfaces 105c and 106c of the third protruding portion 127c. Fourth rail raceway surfaces 97c and 98c are provided as a pair, one on each of side surfaces 107c and 108c of the fourth protruding portion 128c.

As viewed in the longitudinal direction, the first slider 21c, the second slider 22c, the third slider 23c, and the fourth slider 24c are provided spaced apart from each other. Specifically, there is a clearance between the first slider 21c and the second slider 22c. There is a clearance between the first slider 21c and the fourth slider 24c. There is a clearance between the third slider 23c and the second slider 22c. There is a clearance between the third slider 23c and the fourth slider 24c.

As viewed in the longitudinal direction, the first slider 21c and the third slider 23c are arranged in parallel, spaced apart in the Z direction. The first protruding portion 125c, the first sidewall portion 121c, the through hole 120c, the third sidewall portion 123c, and the third protruding portion 127c are interposed between the first slider 21c and the third slider 23c. The second slider 22c and the fourth slider 24c are arranged in parallel, spaced apart in the X direction. The second protruding portion 126c, the second sidewall portion 122c, the through hole 120c, the fourth sidewall portion 124c, and the fourth protruding portion 128c are interposed between the second slider 22c and the fourth slider 24c.

As viewed in the longitudinal direction, a planar second mounting surface 28c, which is included in the second slider 22c and is provided with a second mounting hole for another member to be mounted, is inclined with respect to a planar first mounting surface 26c, which is included in the first slider 21c and is provided with a first mounting hole for another member to be mounted. In the present embodiment, the angle of inclination of the second mounting surface 28c with respect to the first mounting surface 26c is 90 degrees. Further, as viewed in the longitudinal direction, a planar fourth mounting surface 38c, which is included in the fourth slider 24c and is provided with a fourth mounting hole for another member to be mounted, is inclined with respect to the first mounting surface 26c. In the present embodiment, the angle of inclination of the fourth mounting surface 38c with respect to the first mounting surface 26c is 90 degrees. It should be noted that as viewed in the longitudinal direction, the first mounting surface 26c and a planar third mounting surface 36c, which is included in the third slider 23c and is provided with a third mounting hole for another member to be mounted, are arranged in parallel. In the present embodiment, the first mounting surface 26c and the third mounting surface 36c are each parallel to the X-Y plane. As viewed in the longitudinal direction, the second mounting surface 28c and the fourth mounting surface 38c are arranged in parallel. In the present embodiment, the second mounting surface 28c and the fourth mounting surface 38c are each parallel to the Y-Z plane. In other words, the first mounting surface 26c, the second mounting surface 28c, the third mounting surface 36c, and the fourth mounting surface 38c are configured to be positioned rotated by 90 degrees each.

The linear motion guide unit 10c having such a configuration can also improve user convenience and allow a plurality of sliders to freely perform linear motion. The present embodiment allows weight reduction while utilizing a plurality of sliders of the same type that are straddled on a rail, such as the second slider.

### Embodiment 4

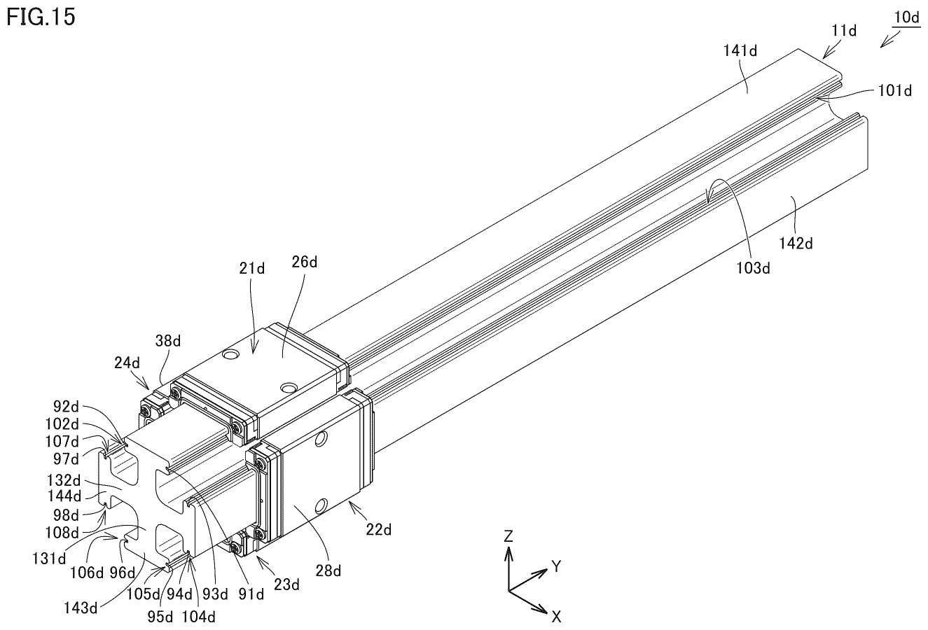

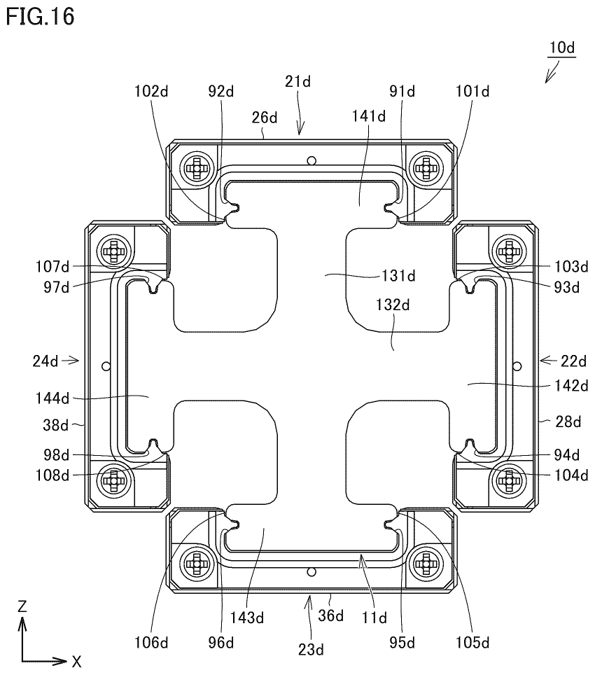

Still yet another embodiment, Embodiment 4, will now be described. FIG. 15 is a schematic perspective view of a linear motion guide unit in Embodiment 4 of the present disclosure. FIG. 16 is a schematic plan view of the linear motion guide unit shown in FIG. 15. FIG. 16 is a view of the linear motion guide unit shown in FIG. 15 in the direction indicated by the arrow Y. The linear motion guide unit of Embodiment 4 basically has a similar configuration and provides similar effects as in the case of Embodiment 1. However, the linear motion guide unit of Embodiment 4 differs from the case of Embodiment 1 in the configurations of the track rail and the sliders.

Referring to FIGS. 15 and 16, the linear motion guide unit 10d of Embodiment 4 includes a track rail 11d, a first slider 21d, a plurality of first balls (not shown) as a plurality of first rolling elements, a second slider 22d, a plurality of second balls (not shown) as a plurality of second rolling elements, a third slider 23d, a plurality of third balls (not shown) as a plurality of third rolling elements, a fourth slider 24d, and a plurality of fourth balls (not shown) as a plurality of fourth rolling elements. The track rail 11d is configured to extend straight in the longitudinal direction, the Y direction.

The first slider 21d, the second slider 22d, the third slider 23d, and the fourth slider 24d are each relatively movably attached to the track rail 11d. In the present embodiment, the first slider 21d is attached to the back side of the track rail 11d. The second slider 22d is attached to the right side of the track rail 11d. The third slider 23d is attached to the front side of the track rail 11d. The fourth slider 24d is attached to the left side of the track rail 11d. The first slider 21d, the second slider 22d, the third slider 23d, and the fourth slider 24d are each configured to be movable in the longitudinal direction (Y direction).

The first slider 21d, the second slider 22d, the third slider 23d, and the fourth slider 24d each have the same configuration as the second slider 22a of Embodiment 1 described above, so the description thereof will not be repeated. In other words, in the present embodiment, sliders that all have the same configuration are used.

The track rail 11d has a shape in which a first plate-shaped portion 131d and a second plate-shaped portion 132d each extending in the longitudinal direction are crossed and connected to each other at their centers. The first plate-shaped portion 131d has one end provided with a first support portion 141d of a flat plate shape extending in the longitudinal direction. The second plate-shaped portion 132d has one end provided with a second support portion 142d of a flat plate shape extending in the longitudinal direction. The first plate-shaped portion 131d has another end provided with a third support portion 143d of a flat plate shape extending in the longitudinal direction. The second plate-shaped portion 132d has another end provided with a fourth support portion 144d of a flat plate shape extending in the longitudinal direction.

First rail raceway surfaces 91d and 92d are provided as a pair, one on each of side surfaces 101d and 102d of the first support portion 141d. Second rail raceway surfaces 93d and 94d are provided as a pair, one on each of side surfaces 103d and 104d of the second support portion 142d. Third rail raceway surfaces 95d and 96d are provided as a pair, one on each of side surfaces 105d and 106d of the third support portion 143d. Fourth rail raceway surfaces 97d and 98d are provided as a pair, one on each of side surfaces 107d and 108d of the fourth support portion 144d.

As viewed in the longitudinal direction, the first slider 21d, the second slider 22d, the third slider 23d, and the fourth slider 24d are provided spaced apart from each other. Specifically, there is a clearance between the first slider 21d and the second slider 22d. There is a clearance between the first slider 21d and the fourth slider 24d. There is a clearance between the third slider 23d and the second slider 22d. There is a clearance between the third slider 23d and the fourth slider 24d.

As viewed in the longitudinal direction, the first slider 21d and the third slider 23d are arranged in parallel, spaced apart in the Z direction. The first support portion 141c, the first plate-shaped portion 131d, and the third support portion 143d are interposed between the first slider 21d and the third slider 23d. The second slider 22d and the fourth slider 24d are arranged in parallel, spaced apart in the X direction. The second support portion 142c, the second plate-shaped portion 132d, and the fourth support portion 144d are interposed between the second slider 22d and the fourth slider 24d.

As viewed in the longitudinal direction, a planar second mounting surface 28d, which is included in the second slider 22d and is provided with a second mounting hole for another member to be mounted, is inclined with respect to a planar first mounting surface 26d, which is included in the first slider 21d and is provided with a first mounting hole for another member to be mounted. In the present embodiment, the angle of inclination of the second mounting surface 28d with respect to the first mounting surface 26d is 90 degrees. Further, as viewed in the longitudinal direction, a planar fourth mounting surface 38d, which is included in the fourth slider 24d and is provided with a fourth mounting hole for another member to be mounted, is inclined with respect to the first mounting surface 26d. In the present embodiment, the angle of inclination of the fourth mounting surface 38d with respect to the first mounting surface 26d is 90 degrees. It should be noted that as viewed in the longitudinal direction, the first mounting surface 26d and a planar third mounting surface 36d, which is included in the third slider 23d and is provided with a third mounting hole for another member to be mounted, are arranged in parallel. In the present embodiment, the first mounting surface 26d and the third mounting surface 36d are each parallel to the X-Y plane. As viewed in the longitudinal direction, the second mounting surface 28d and the fourth mounting surface 38d are arranged in parallel. In the present embodiment, the second mounting surface 28d and the fourth mounting surface 38d are each parallel to the Y-Z plane. In other words, the first mounting surface 26d, the second mounting surface 28d, the third mounting surface 36d, and the fourth mounting surface 38d are configured to be positioned rotated by 90 degrees each.

The linear motion guide unit 10d having such a configuration can also improve user convenience and allow a plurality of sliders to freely perform linear motion. The present embodiment allows weight reduction while utilizing a plurality of sliders of the same type that are straddled on a rail, such as the second slider.

### Embodiment 5

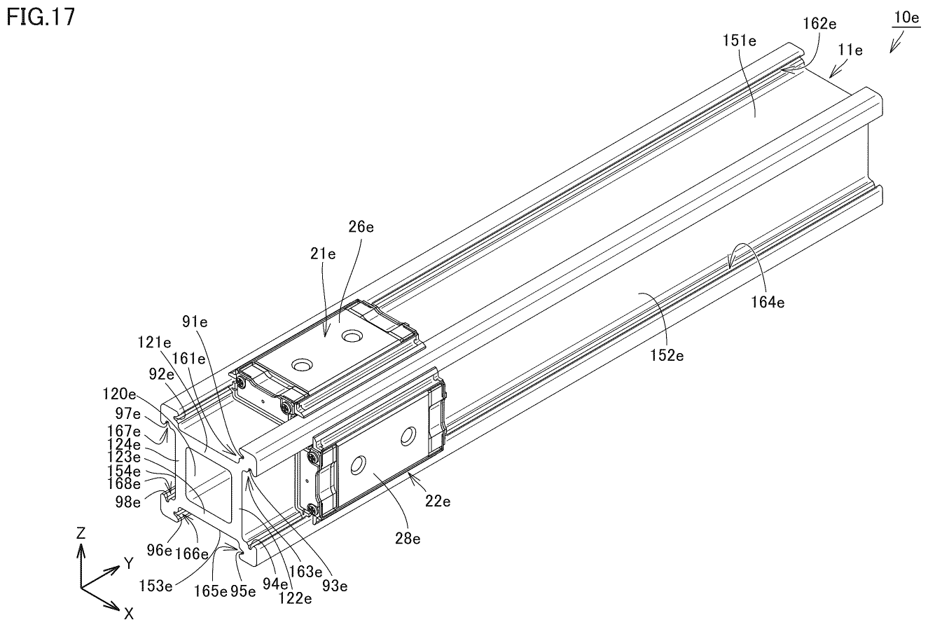

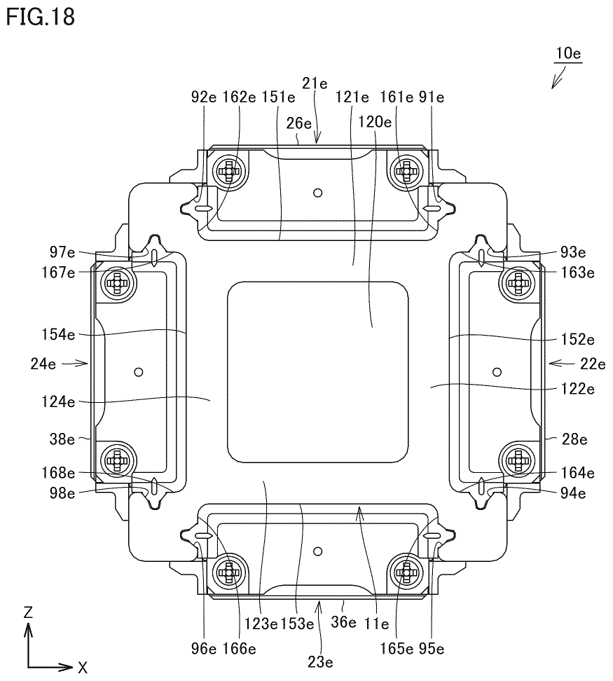

Still yet another embodiment, Embodiment 5, will now be described. FIG. 17 is a schematic perspective view of a linear motion guide unit in Embodiment 5 of the present disclosure. FIG. 18 is a schematic front view of the linear motion guide unit shown in FIG. 17. FIG. 18 is a view of the linear motion guide unit shown in FIG. 17 in the direction indicated by the arrow Y. The linear motion guide unit of Embodiment 5 basically has a similar configuration and provides similar effects as in the case of Embodiment 1. However, the linear motion guide unit of Embodiment 5 differs from the case of Embodiment 1 in the configurations of the track rail and the sliders.

Referring to FIGS. 17 and 18, the linear motion guide unit 10e of Embodiment 5 includes a track rail 11e, a first slider 21e, a plurality of first balls (not shown) as a plurality of first rolling elements, a second slider 22e, a plurality of second balls (not shown) as a plurality of second rolling elements, a third slider 23e, a plurality of third balls (not shown) as a plurality of third rolling elements, a fourth slider 24e, and a plurality of fourth balls (not shown) as a plurality of fourth rolling elements. The track rail 11e is configured to extend straight in the longitudinal direction, the Y direction.

The first slider 21e, the second slider 22e, the third slider 23e, and the fourth slider 24e are each relatively movably attached to the track rail 11e. In the present embodiment, the first slider 21e is attached to the back side of the track rail 11e. The second slider 22e is attached to the right side of the track rail 11e. The third slider 23e is attached to the front side of the track rail 11e. The fourth slider 24e is attached to the left side of the track rail 11e. The first slider 21e, the second slider 22e, the third slider 23e, and the fourth slider 24ce are each configured to be movable in the longitudinal direction (Y direction).

The first slider 21e, the second slider 22e, the third slider 23e, and the fourth slider 24e each have the same configuration as the first slider 21a of Embodiment 1 described above, so the description thereof will not be repeated. In other words, in the present embodiment, sliders that all have the same configuration are used.

The track rail 11e has a hollow quadrangular prism shape. That is, the track rail 11e has a through hole 120e penetrating therethrough in the longitudinal direction. The track rail 11e includes a first sidewall portion 121e, a second sidewall portion 122e, a third sidewall portion 123e, and a fourth sidewall portion 124e. The first sidewall portion 121e extends in the longitudinal direction and has a rectangular shape as viewed in its thickness direction. The second sidewall portion 122e extends in the longitudinal direction and has a rectangular shape as viewed in its thickness direction, and is arranged in a direction orthogonal to the first sidewall portion 121e. The third sidewall portion 123e extends in the longitudinal direction and has a rectangular shape as viewed in its thickness direction, and is arranged in a direction orthogonal to the second sidewall portion 122e and parallel to the first sidewall portion 121e. The fourth sidewall portion 124e extends in the longitudinal direction and has a rectangular shape as viewed in its thickness direction, and is arranged in a direction orthogonal to the first sidewall portion 121e and parallel to the second sidewall portion 122e. The through hole 120e is formed by the first sidewall portion 121e, the second sidewall portion 122e, the third sidewall portion 123e, and the fourth sidewall portion 124e.

The first sidewall portion 121e, the second sidewall portion 122e, the third sidewall portion 123e, and the fourth sidewall portion 124e have a first groove-shaped portion 151e, a second groove-shaped portion 152e, a third groove-shaped portion 153e, and a fourth groove-shaped portion 154e, respectively, which extend in the longitudinal direction and are concaved inward.

First rail raceway surfaces 91e and 92e are provided as a pair, one in each of regions 161e and 162e facing each other across the first groove-shaped portion 151e. Second rail raceway surfaces 93e and 94e are provided as a pair, one in each of regions 163e and 164e facing each other across the second groove-shaped portion 152e. Third rail raceway surfaces 95e and 96e are provided as a pair, one in each of regions 165e and 166e facing each other across the third groove-shaped portion 153e. Fourth rail raceway surfaces 97e and 98e are provided as a pair, one in each of regions 167e and 168e facing each other across the fourth groove-shaped portion 154e.

As viewed in the longitudinal direction, the first slider 21e, the second slider 22e, the third slider 23e, and the fourth slider 24e are provided spaced apart from each other. Specifically, there is a clearance between the first slider 21e and the second slider 22e. There is a clearance between the first slider 21e and the fourth slider 24e. There is a clearance between the third slider 23e and the second slider 22e. There is a clearance between the third slider 23e and the fourth slider 24e.

As viewed in the longitudinal direction, the first slider 21e and the third slider 23e are arranged in parallel, spaced apart in the Z direction. The first sidewall portion 121e, the through hole 120e, and the third sidewall portion 123e are interposed between the first slider 21e and the third slider 23e. The second slider 22e and the fourth slider 24e are arranged in parallel, spaced apart in the X direction. The second sidewall portion 122e, the through hole 120e, and the fourth sidewall portion 124e are interposed between the second slider 22e and the fourth slider 24e.

As viewed in the longitudinal direction, a planar second mounting surface 28e, which is included in the second slider 22e and is provided with a second mounting hole for another member to be mounted, is inclined with respect to a planar first mounting surface 26e, which is included in the first slider 21e and is provided with a first mounting hole for another member to be mounted. In the present embodiment, the angle of inclination of the second mounting surface 28e with respect to the first mounting surface 26e is 90 degrees. Further, as viewed in the longitudinal direction, a planar fourth mounting surface 38e, which is included in the fourth slider 24e and is provided with a fourth mounting hole for another member to be mounted, is inclined with respect to the first mounting surface 26e. In the present embodiment, the angle of inclination of the fourth mounting surface 38e with respect to the first mounting surface 26e is 90 degrees. It should be noted that as viewed in the longitudinal direction, the first mounting surface 26e and a planar third mounting surface 36e, which is included in the third slider 23e and is provided with a third mounting hole for another member to be mounted, are arranged in parallel. In the present embodiment, the first mounting surface 26e and the third mounting surface 36e are each parallel to the X-Y plane. As viewed in the longitudinal direction, the second mounting surface 28e and the fourth mounting surface 38e are arranged in parallel. In the present embodiment, the second mounting surface 28e and the fourth mounting surface 38e are each parallel to the Y-Z plane. In other words, the first mounting surface 26e, the second mounting surface 28e, the third mounting surface 36e, and the fourth mounting surface 38e are configured to be positioned rotated by 90 degrees each.

The linear motion guide unit 10e having such a configuration can also improve user convenience and allow a plurality of sliders to freely perform linear motion. In the present embodiment, the rigidity of the track rail 11e can be increased while allowing weight reduction.

### OTHER EMBODIMENTS

While the rolling elements are balls in the above embodiments, not limited thereto, the rolling elements may be rollers. Of course, the first slider may be configured to correspond to balls and the second slider may be configured to correspond to rollers. In addition, retaining plates for retaining the rolling elements may be secured to the carriage using bolts.

While the second slider is inclined at an angle of 90 degrees with respect to the first slider in the above embodiments, not limited thereto, it may be inclined at an angle less than 90 degrees, such as 30, 45, or 60 degrees, or at an angle greater than 90 degrees, such as 120, 135, or 150 degrees.

While the first slider, the second slider, the third slider, and the fourth slider are included in the above embodiments, the configuration is not limited thereto. Either one or both of the third slider and the fourth slider may not be included.

In the above embodiments, in the case where the track rail has a quadrangular prism shape, the first slider and the second slider may be disposed inside the through hole.

It should be understood that the embodiments disclosed herein are illustrative and non-restrictive in every respect. The scope of the present invention is defined by the terms of the claims, and is intended to include any modifications within the scope and meaning equivalent to the terms of the claims.

### REFERENCE SIGNS LIST

10a, 10b, 10c, 10d, 10e: linear motion guide unit; 11a, 11b, 11c, 11d, 11e: track rail; 12a: first ball; 12b: second ball; 12c: third ball; 12d: fourth ball; 13a, 14a: first looped path; 13b, 14b: second looped path; 15a, 16a: first load-carrying race; 15b, 16b: second load-carrying race; 17a: rail front end surface; 18a: rail rear end surface; 21a, 21b, 21c, 21d, 21e: first slider; 22a, 22b, 22c, 22d, 22e: second slider; 23a, 23b, 23c, 23d, 23e: third slider; 24a, 24b, 24c, 24d, 24e: fourth slider; 25a: first mounting hole; 26a, 26b, 26c, 26d, 26e: first mounting surface; 27a: second mounting hole; 28a, 28b, 28c, 28d, 28e: second mounting surface; 29a: base portion; 31a, 32a: first slider raceway surface; 33a, 34a: second slider raceway surface; 35a: third mounting hole; 36a, 36b, 36c, 36d, 36e: third mounting surface; 37a: fourth mounting hole; 38a, 38b, 38c, 38d, 38e: fourth mounting surface; 39a, 40a: sleeve portion; 41a: first carriage; 42a: first front-side end cap; 43a: first rear-side end cap; 44a: first front-side end seal; 45a: first rear-side end seal; 46a, 47a: first carriage circulation passage; 48a, 49a, 68a, 69a: lubricating member; 51a, 52a: first front-side end cap circulation passage; 53a, 54a: first rear-side end cap circulation passage; 55a, 56a: first retaining plate; 57a, 58a: first retaining band; 61a: second carriage; 62a: second front-side end cap; 63a: second rear-side end cap; 64a: second front-side end seal; 65a: second rear-side end seal; 66a, 67a: second carriage circulation passage; 71a, 72a: second front-side end cap circulation passage; 73a, 74a: second rear-side end cap circulation passage; 77a, 78a: second retaining band; 81a, 81b: first flat plate portion; 82a, 82b: second flat plate portion; 83a, 83b: third flat plate portion; 84a, 84b: first surface; 85a, 85b: second surface; 86a, 86b, 87a, 87b, 88a, 88b, 89a, 89b: surface; 91a, 91b, 91c, 91d, 91e, 92a, 92b, 92c, 92d, 92e: first rail raceway surface; 93a, 93b, 93c, 93d, 93e, 94a, 94b, 94c, 94d, 94e: second rail raceway surface; 95a, 95b, 95c, 95d, 95e, 96a, 96b, 96c, 96d, 96e: third rail raceway surface; 97a, 97b, 97c, 97d, 97e, 98a, 98b, 98c, 98d, 98e: fourth rail raceway surface; 101a, 101b, 101c, 101d, 102a, 102b, 102c, 102d, 103a, 103b, 103c, 103d, 104a, 104b, 104c, 104d, 105c, 105d, 106c, 106d, 107c, 107d, 108c, 108d, 113a, 113b, 114a, 114b, 115a, 115b, 116a, 116b: side surface; 111b, 112b: thick-walled portion; 120c, 120e: through hole; 121c, 121e: first sidewall portion; 122c, 122e: second sidewall portion; 123c, 123e: third sidewall portion; 124c, 124e: fourth sidewall portion; 125c: first protruding portion; 126c: second protruding portion; 127c: third protruding portion; 128c: fourth protruding portion; 131d: first plate-shaped portion; 132d: second plate-shaped portion; 141d: first support portion; 142d: second support portion; 143d: third support portion; 144d: fourth support portion; 151e: first groove-shaped portion; 152e: second groove-shaped portion; 153e: third groove-shaped portion; 154e: fourth groove-shaped portion; and 161e, 162e, 163e, 164e, 165e, 166e, 167e, 168e: region.

1. A linear motion guide unit comprising:
a track rail having a first rail raceway surface and a second rail raceway surface each extending in a longitudinal direction;
a first slider relatively movably attached to the track rail, the first slider having a first slider raceway surface facing the first rail raceway surface and a planar first mounting surface provided with a first mounting hole for another member to be mounted;
a second slider relatively movably attached to the track rail, the second slider having a second slider raceway surface facing the second rail raceway surface and a planar second mounting surface provided with a second mounting hole for another member to be mounted;
a plurality of first rolling elements rolling on a first load-carrying race composed of the first rail raceway surface and the first slider raceway surface; and
a plurality of second rolling elements rolling on a second load-carrying race composed of the second rail raceway surface and the second slider raceway surface;
the first slider being provided spaced apart from the second slider as viewed in the longitudinal direction,
the second mounting surface being inclined with respect to the first mounting surface as viewed in the longitudinal direction.

2. The linear motion guide unit according to claim 1, wherein an angle of inclination of the second mounting surface with respect to the first mounting surface is 90 degrees.

3. The linear motion guide unit according to claim 1, wherein
the track rail further has a third rail raceway surface extending in the longitudinal direction,
the linear motion guide unit further includes
a third slider relatively movably attached to the track rail, the third slider having a third slider raceway surface facing the third rail raceway surface and a planar third mounting surface provided with a third mounting hole for another member to be mounted, and
a plurality of third rolling elements rolling on a third load-carrying race composed of the third rail raceway surface and the third slider raceway surface,
the third slider is provided spaced apart from each of the first slider and the second slider as viewed in the longitudinal direction, and
the third mounting surface is inclined with respect to at least one of the first mounting surface and the second mounting surface as viewed in the longitudinal direction.

4. The linear motion guide unit according to claim 3, wherein the third mounting surface is parallel to the first mounting surface as viewed in the longitudinal direction.

5. The linear motion guide unit according to claim 3, wherein
the track rail further has a fourth rail raceway surface extending in the longitudinal direction,
the linear motion guide unit further includes
a fourth slider relatively movably attached to the track rail, the fourth slider having a fourth slider raceway surface facing the fourth rail raceway surface and a planar fourth mounting surface provided with a fourth mounting hole for another member to be mounted, and
a plurality of fourth rolling elements rolling on a fourth load-carrying race composed of the fourth rail raceway surface and the fourth slider raceway surface,
the fourth slider is provided spaced apart from each of the first slider, the second slider, and the third slider as viewed in the longitudinal direction, and
the fourth mounting surface is inclined with respect to at least one of the first mounting surface, the second mounting surface, and the third mounting surface as viewed in the longitudinal direction.

6. The linear motion guide unit according to claim 5, wherein the fourth mounting surface is parallel to the second mounting surface as viewed in the longitudinal direction.

7. The linear motion guide unit according to claim 5, wherein
the track rail includes
a first flat plate portion extending in the longitudinal direction and having a rectangular shape as viewed in a thickness direction,
a second flat plate portion extending in the longitudinal direction and having a rectangular shape as viewed in a thickness direction, the second flat plate portion being arranged in a direction orthogonal to the first flat plate portion, and
a third flat plate portion extending in the longitudinal direction and having a rectangular shape as viewed in a thickness direction, the third flat plate portion being arranged in a direction orthogonal to the first flat plate portion and parallel to the second flat plate portion,
the first flat plate portion includes a first surface located on one side in the thickness direction and a second surface located on another side in the thickness direction,
the second flat plate portion is connected, at a central region of a surface on one side in the thickness direction, to one end of the first flat plate portion,
the third flat plate portion is connected, at a central region of a surface on another side in the thickness direction, to another end of the first flat plate portion,
the first rail raceway surface is provided in a pair, on the first surface side, one on the surface located on the one side in the thickness direction of the second flat plate portion and one on the surface located on the other side in the thickness direction of the third flat plate portion,
the third rail raceway surface is provided in a pair, on the second surface side, one on the surface located on the one side in the thickness direction of the second flat plate portion and one on the surface located on the other side in the thickness direction of the third flat plate portion,
the second rail raceway surface is provided in a pair, one on each of side surfaces of the second flat plate portion, and
the fourth rail raceway surface is provided in a pair, one on each of side surfaces of the third flat plate portion.

8. The linear motion guide unit according to claim 5, wherein
the track rail includes
a first flat plate portion extending in the longitudinal direction and having a rectangular shape as viewed in a thickness direction,
a second flat plate portion extending in the longitudinal direction and having a rectangular shape as viewed in a thickness direction, the second flat plate portion being arranged in a direction orthogonal to the first flat plate portion, and
a third flat plate portion extending in the longitudinal direction and having a rectangular shape as viewed in a thickness direction, the third flat plate portion being arranged in a direction orthogonal to the first flat plate portion and parallel to the second flat plate portion,
the first flat plate portion includes a first surface located on one side in the thickness direction and a second surface located on another side in the thickness direction,
the first flat plate portion includes a first thick-walled portion protruding in the thickness direction from the first surface and a second thick-walled portion protruding in the thickness direction from the second surface,
the second flat plate portion is connected, at a central region of a surface on one side in the thickness direction, to one end of the first flat plate portion,
the third flat plate portion is connected, at a central region of a surface on another side in the thickness direction, to another end of the first flat plate portion,
the first rail raceway surface is provided in a pair, one on each of side surfaces of the first thick-walled portion,
the third rail raceway surface is provided in a pair, one on each of side surfaces of the second thick-walled portion,
the second rail raceway surface is provided in a pair, one on each of side surfaces of the second flat plate portion, and
the fourth rail raceway surface is provided in a pair, one on each of side surfaces of the third flat plate portion.

9. The linear motion guide unit according to claim 5, wherein
the track rail has a hollow quadrangular prism shape and includes
a first sidewall portion extending in the longitudinal direction and having a rectangular shape as viewed in a thickness direction,
a second sidewall portion extending in the longitudinal direction and having a rectangular shape as viewed in a thickness direction, the second sidewall portion being arranged in a direction orthogonal to the first sidewall portion,
a third sidewall portion extending in the longitudinal direction and having a rectangular shape as viewed in a thickness direction, the third sidewall portion being arranged in a direction orthogonal to the second sidewall portion and parallel to the first sidewall portion, and
a fourth sidewall portion extending in the longitudinal direction and having a rectangular shape as viewed in a thickness direction, the fourth sidewall portion being arranged in a direction orthogonal to the first sidewall portion and parallel to the second sidewall portion,
the first sidewall portion, the second sidewall portion, the third sidewall portion, and the fourth sidewall portion include a first protruding portion, a second protruding portion, a third protruding portion, and a fourth protruding portion, respectively, which protrude outward,
the first rail raceway surface is provided in a pair, one on each of side surfaces of the first protruding portion,
the second rail raceway surface is provided in a pair, one on each of side surfaces of the second protruding portion,
the third rail raceway surface is provided in a pair, one on each of side surfaces of the third protruding portion, and
the fourth rail raceway surface is provided in a pair, one on each of side surfaces of the fourth protruding portion.

10. The linear motion guide unit according to claim 5, wherein
the track rail has a shape in which a first plate-shaped portion and a second plate-shaped portion each extending in the longitudinal direction are crossed and connected to each other at centers thereof,
the first plate-shaped portion has one end provided with a first support portion of a flat plate shape extending in the longitudinal direction,
the second plate-shaped portion has one end provided with a second support portion of a flat plate shape extending in the longitudinal direction,
the first plate-shaped portion has another end provided with a third support portion of a flat plate shape extending in the longitudinal direction,
the second plate-shaped portion has another end provided with a fourth support portion of a flat plate shape extending in the longitudinal direction,
the first rail raceway surface is provided in a pair, one on each of side surfaces of the first support portion,
the second rail raceway surface is provided in a pair, one on each of side surfaces of the second support portion,
the third rail raceway surface is provided in a pair, one on each of side surfaces of the third support portion, and
the fourth rail raceway surface is provided in a pair, one on each of side surfaces of the fourth support portion.

11. The linear motion guide unit according to claim 5, wherein
the track rail has a hollow quadrangular prism shape and includes
a first sidewall portion extending in the longitudinal direction and having a rectangular shape as viewed in a thickness direction,
a second sidewall portion extending in the longitudinal direction and having a rectangular shape as viewed in a thickness direction, the second sidewall portion being arranged in a direction orthogonal to the first sidewall portion,
a third sidewall portion extending in the longitudinal direction and having a rectangular shape as viewed in a thickness direction, the third sidewall portion being arranged in a direction orthogonal to the second sidewall portion and parallel to the first sidewall portion, and
a fourth sidewall portion extending in the longitudinal direction and having a rectangular shape as viewed in a thickness direction, the fourth sidewall portion being arranged in a direction orthogonal to the first sidewall portion and parallel to the second sidewall portion,
the first sidewall portion, the second sidewall portion, the third sidewall portion, and the fourth sidewall portion have a first groove-shaped portion, a second groove-shaped portion, a third groove-shaped portion, and a fourth groove-shaped portion, respectively, which extend in the longitudinal direction and are concaved inward,
the first rail raceway surface is provided in a pair, one in each of regions facing each other across the first groove-shaped portion,
the second rail raceway surface is provided in a pair, one in each of regions facing each other across the second groove-shaped portion,
the third rail raceway surface is provided in a pair, one in each of regions facing each other across the third groove-shaped portion, and
the fourth rail raceway surface is provided in a pair, one in each of regions facing each other across the fourth groove-shaped portion.

12. The linear motion guide unit according to claim 1, wherein at least one of the first rolling elements and the second rolling elements are balls.

13. The linear motion guide unit according to claim 2, wherein
the track rail further has a third rail raceway surface extending in the longitudinal direction,
the linear motion guide unit further includes
a third slider relatively movably attached to the track rail, the third slider having a third slider raceway surface facing the third rail raceway surface and a planar third mounting surface provided with a third mounting hole for another member to be mounted, and
a plurality of third rolling elements rolling on a third load-carrying race composed of the third rail raceway surface and the third slider raceway surface,
the third slider is provided spaced apart from each of the first slider and the second slider as viewed in the longitudinal direction, and
the third mounting surface is inclined with respect to at least one of the first mounting surface and the second mounting surface as viewed in the longitudinal direction.

14. The linear motion guide unit according to claim 4, wherein
the track rail further has a fourth rail raceway surface extending in the longitudinal direction,
the linear motion guide unit further includes
a fourth slider relatively movably attached to the track rail, the fourth slider having a fourth slider raceway surface facing the fourth rail raceway surface and a planar fourth mounting surface provided with a fourth mounting hole for another member to be mounted, and
a plurality of fourth rolling elements rolling on a fourth load-carrying race composed of the fourth rail raceway surface and the fourth slider raceway surface,
the fourth slider is provided spaced apart from each of the first slider, the second slider, and the third slider as viewed in the longitudinal direction, and
the fourth mounting surface is inclined with respect to at least one of the first mounting surface, the second mounting surface, and the third mounting surface as viewed in the longitudinal direction.

15. The linear motion guide unit according to claim 6, wherein
the track rail includes
a first flat plate portion extending in the longitudinal direction and having a rectangular shape as viewed in a thickness direction,
a second flat plate portion extending in the longitudinal direction and having a rectangular shape as viewed in a thickness direction, the second flat plate portion being arranged in a direction orthogonal to the first flat plate portion, and
a third flat plate portion extending in the longitudinal direction and having a rectangular shape as viewed in a thickness direction, the third flat plate portion being arranged in a direction orthogonal to the first flat plate portion and parallel to the second flat plate portion,
the first flat plate portion includes a first surface located on one side in the thickness direction and a second surface located on another side in the thickness direction,
the second flat plate portion is connected, at a central region of a surface on one side in the thickness direction, to one end of the first flat plate portion,
the third flat plate portion is connected, at a central region of a surface on another side in the thickness direction, to another end of the first flat plate portion,
the first rail raceway surface is provided in a pair, on the first surface side, one on the surface located on the one side in the thickness direction of the second flat plate portion and one on the surface located on the other side in the thickness direction of the third flat plate portion,
the third rail raceway surface is provided in a pair, on the second surface side, one on the surface located on the one side in the thickness direction of the second flat plate portion and one on the surface located on the other side in the thickness direction of the third flat plate portion,
the second rail raceway surface is provided in a pair, one on each of side surfaces of the second flat plate portion, and
the fourth rail raceway surface is provided in a pair, one on each of side surfaces of the third flat plate portion.

16. The linear motion guide unit according to claim 6, wherein
the track rail includes
a first flat plate portion extending in the longitudinal direction and having a rectangular shape as viewed in a thickness direction,
a second flat plate portion extending in the longitudinal direction and having a rectangular shape as viewed in a thickness direction, the second flat plate portion being arranged in a direction orthogonal to the first flat plate portion, and
a third flat plate portion extending in the longitudinal direction and having a rectangular shape as viewed in a thickness direction, the third flat plate portion being arranged in a direction orthogonal to the first flat plate portion and parallel to the second flat plate portion,
the first flat plate portion includes a first surface located on one side in the thickness direction and a second surface located on another side in the thickness direction,
the first flat plate portion includes a first thick-walled portion protruding in the thickness direction from the first surface and a second thick-walled portion protruding in the thickness direction from the second surface,
the second flat plate portion is connected, at a central region of a surface on one side in the thickness direction, to one end of the first flat plate portion,
the third flat plate portion is connected, at a central region of a surface on another side in the thickness direction, to another end of the first flat plate portion,
the first rail raceway surface is provided in a pair, one on each of side surfaces of the first thick-walled portion,
the third rail raceway surface is provided in a pair, one on each of side surfaces of the second thick-walled portion,
the second rail raceway surface is provided in a pair, one on each of side surfaces of the second flat plate portion, and
the fourth rail raceway surface is provided in a pair, one on each of side surfaces of the third flat plate portion.

17. The linear motion guide unit according to claim 6, wherein
the track rail has a hollow quadrangular prism shape and includes
a first sidewall portion extending in the longitudinal direction and having a rectangular shape as viewed in a thickness direction,
a second sidewall portion extending in the longitudinal direction and having a rectangular shape as viewed in a thickness direction, the second sidewall portion being arranged in a direction orthogonal to the first sidewall portion,
a third sidewall portion extending in the longitudinal direction and having a rectangular shape as viewed in a thickness direction, the third sidewall portion being arranged in a direction orthogonal to the second sidewall portion and parallel to the first sidewall portion, and
a fourth sidewall portion extending in the longitudinal direction and having a rectangular shape as viewed in a thickness direction, the fourth sidewall portion being arranged in a direction orthogonal to the first sidewall portion and parallel to the second sidewall portion,
the first sidewall portion, the second sidewall portion, the third sidewall portion, and the fourth sidewall portion include a first protruding portion, a second protruding portion, a third protruding portion, and a fourth protruding portion, respectively, which protrude outward,
the first rail raceway surface is provided in a pair, one on each of side surfaces of the first protruding portion,
the second rail raceway surface is provided in a pair, one on each of side surfaces of the second protruding portion,
the third rail raceway surface is provided in a pair, one on each of side surfaces of the third protruding portion, and
the fourth rail raceway surface is provided in a pair, one on each of side surfaces of the fourth protruding portion.

18. The linear motion guide unit according to claim 6, wherein
the track rail has a shape in which a first plate-shaped portion and a second plate-shaped portion each extending in the longitudinal direction are crossed and connected to each other at centers thereof,
the first plate-shaped portion has one end provided with a first support portion of a flat plate shape extending in the longitudinal direction,
the second plate-shaped portion has one end provided with a second support portion of a flat plate shape extending in the longitudinal direction,
the first plate-shaped portion has another end provided with a third support portion of a flat plate shape extending in the longitudinal direction,
the second plate-shaped portion has another end provided with a fourth support portion of a flat plate shape extending in the longitudinal direction,
the first rail raceway surface is provided in a pair, one on each of side surfaces of the first support portion,
the second rail raceway surface is provided in a pair, one on each of side surfaces of the second support portion,
the third rail raceway surface is provided in a pair, one on each of side surfaces of the third support portion, and
the fourth rail raceway surface is provided in a pair, one on each of side surfaces of the fourth support portion.

19. The linear motion guide unit according to claim 6, wherein
the track rail has a hollow quadrangular prism shape and includes
a first sidewall portion extending in the longitudinal direction and having a rectangular shape as viewed in a thickness direction,
a second sidewall portion extending in the longitudinal direction and having a rectangular shape as viewed in a thickness direction, the second sidewall portion being arranged in a direction orthogonal to the first sidewall portion,
a third sidewall portion extending in the longitudinal direction and having a rectangular shape as viewed in a thickness direction, the third sidewall portion being arranged in a direction orthogonal to the second sidewall portion and parallel to the first sidewall portion, and
a fourth sidewall portion extending in the longitudinal direction and having a rectangular shape as viewed in a thickness direction, the fourth sidewall portion being arranged in a direction orthogonal to the first sidewall portion and parallel to the second sidewall portion,
the first sidewall portion, the second sidewall portion, the third sidewall portion, and the fourth sidewall portion have a first groove-shaped portion, a second groove-shaped portion, a third groove-shaped portion, and a fourth groove-shaped portion, respectively, which extend in the longitudinal direction and are concaved inward,
the first rail raceway surface is provided in a pair, one in each of regions facing each other across the first groove-shaped portion,
the second rail raceway surface is provided in a pair, one in each of regions facing each other across the second groove-shaped portion,
the third rail raceway surface is provided in a pair, one in each of regions facing each other across the third groove-shaped portion, and
the fourth rail raceway surface is provided in a pair, one in each of regions facing each other across the fourth groove-shaped portion.

20. The linear motion guide unit according to claim 2, wherein at least one of the first rolling elements and the second rolling elements are balls.
